(19) United States
(12) Patent Application Publication
(10) Pub. No.: US 2026/0227738 A1
(43) Pub. Date: Aug. 6, 2026

(54) IMAGE FORMING APPARATUS

(71) Applicant: CANON KABUSHIKI KAISHA, Tokyo (JP)

(72) Inventor: YOHEI SUZUKI, Shizuoka (JP)

(21) Appl. No.: 19/453,692

(22) Filed: Jan. 20, 2026

(30) Foreign Application Priority Data
Jan. 21, 2025 (JP) 2025-008796

(51) Int. Cl. G03G 21/16; E05F 3/14; G03G 15/00

(52) U.S. Cl. CPC G03G 21/1633; E05F 3/14; G03G 15/6514; G03G 21/1647; E05Y 2201/21; E05Y 2201/266; G03G 2221/1657

(57) ABSTRACT

An image forming apparatus includes a main assembly; a door, a moving portion, a damper and first and second transmitting portions. The door shifts from one state of an open state to the main assembly and a closed state to the other state by rotating to the main assembly due to its own weight. The moving portion moves relative to both the main assembly and the door with rotation of the door. The damper generates a braking force for braking the door by moving with movement of the moving portion. Each of the moving portion and the door is provided with one of the first and second transmitting portions. When the door is shifted from the one state to the other state, the braking force is changed by changing a positional relationship between the first and second transmitting portions with the movement of the moving portion.

### BACKGROUND

### Field of the Technology

The present invention relates to an image forming apparatus including an open/close portion.

### Description of the Related Art

Conventionally, to an image forming apparatus such as a laser beam printer, an open/close portion, which is openable and closable by being swung, such as a cover for a manual feed feeding portion and a door for jam clearance is provided. For example, the cover for the manual feed feeding portion is opened and closed, about a swing axis located on a lower end portion side thereof when positioned at a closed position, so as an upper end portion side thereof when positioned at the closed position to be rotated, by being swung between the closed position and an open position. Hereinafter, it will be described as an open/close portion, with mainly taking the cover for the manual feed feeding portion having the configuration as described above as an example.

The cover for the manual feed feeding portion is, in general, configured so as to be openable and closable by a user (an operator) operating the cover with his/her hand. When the user removes his/her hand from the cover upon opening the cover, the cover for the manual feed feeding portion moves to the open position due to own weight thereof, etc. without the operation by the user. In order to suppress generation of damage to a component such as the manual feed feeding portion and of collision sound due to impact generated in such cases, there is a case in which a braking mechanism is incorporated into the image forming apparatus.

In Japanese Patent Application Laid-Open No. 2007-106506, in a configuration including a manual feed portion, which is provided with a manual feed cover and a sheet stacking table, a configuration, in which between the manual feed cover and the sheet stacking table excluding vicinities of respective swing fulcrums of the manual feed cover and the sheet stacking table, a buffer means such as a plate spring is provided, is proposed.

In addition, in Japanese Patent Application Laid-Open No. 2006-083551, in a configuration including a cover, which is openable and closable by being rotated, a configuration, in which a load converting means which transmits a load for braking the cover, which is supplied from a load supplying portion, to the cover with changing the load to a plurality of levels depending on a rotation angle of the cover, is proposed. The load converting means is configured to include a first gear mechanism provided with a plurality of gear portions with different diameters, which is rotated about a rotation center of the cover, and a second gear mechanism, to which the load is supplied from the load supplying portion such as an oil damper and which is meshed with one of the gear portions in the first gear mechanism.

### SUMMARY

However, with the configuration described in Japanese Patent Application Laid-Open No. 2007-106506, it is not possible to change the braking force applied to the open/close portion depending on an opening angle of the open/close portion. Therefore, it may be difficult to properly reduce the impact in the case in which the open/close portion moves to the open position due to own weight thereof, etc. without the operation by the user.

In addition, with the configuration described in Japanese Patent Application Laid-Open No. 2006-083551, a degree of freedom in disposition of the braking mechanism is low, and it is likely for a size of an apparatus to be increased. In addition, with the configuration described in Japanese Patent Application Laid-Open No. 2006-083551, a degree of freedom in a control of the braking force applied to the open/close portion is low, and upon trying to control the braking force applied to the open/close portion finely, it is likely for the size of the apparatus to be further increased.

Therefore, an object of the present invention is, while suppressing the increase in the size of the apparatus, to improve the degree of freedom in the control of the braking force applied to the open/close portion, and to reduce the impact in the case in which the open/close portion moves due to own weight thereof, etc. without an operation by an operator.

The object described above is achieved with an image forming apparatus according to the present invention. In summary, according to the presentinvention, there is provided an image forming apparatus comprising: a main assembly; an open/close portion configure to take an open state in which the open/close portion is open relative to the main assembly and a closed state in which the open/close portion is closed relative to the main assembly, the open/close portion shifting from one state of the open state and the closed state to the other state by rotating relative to the main assembly due to its own weight; a moving portion coupled with the open/close portion and configured to move relative to both the main assembly and the open/close portion with rotation of the open/close portion; a damper configured to generate a braking force for braking the open/close portion by moving with movement of the moving portion; a first transmitting portion coupled with the damper and configured to transmit the braking force; and a second transmitting portion to which the braking force is transmitted from the first transmitting portion by being in contact with the first transmitting portion and configured to transmit the braking force to the open/close portion, wherein the moving portion is provided with one of the first transmitting portion and the second transmitting portion, wherein the open/close portion is provided with the other one of the first transmitting portion and the second transmitting portion, and wherein when the open/close portion is shifted from the one state to the other state, the braking force transmitted from the first transmitting portion to the second transmitting portion is changed by changing a positional relationship between the first transmitting portion and the second transmitting portion with the movement of the moving portion.

Further features of the present invention will become apparent from the following description of exemplary embodiments with reference to the attached drawings. The following description of embodiments is described by way of example.

### BRIEF DESCRIPTION OF THE DRAWINGS

FIG. 1A is a cross-sectional outline view of an image forming apparatus illustrating a state in which a cover for a manual feed feeding portion is opened.

FIG. 1B is a cross-sectional outline view of the image forming apparatus illustrating a state in which the cover for the manual feed feeding portion is closed.

FIG. 2 is a perspective view of a vicinity of a side surface on a right side of the image forming apparatus illustrating the manual feed feeding portion.

FIG. 3 is an exploded perspective view of the vicinity of the side surface on the right side of the image forming apparatus illustrating the manual feed feeding portion.

FIG. 4 is a perspective view of the manual feed feeding portion.

FIG. 5 is an exploded perspective view of the manual feed feeding portion.

FIG. 6 is an exploded perspective view of a braking mechanism.

FIG. 7 is a graph view showing a relationship between a rotation speed and torque of the braking mechanism.

FIG. 8 is an exploded perspective view of the manual feed feeding portion illustrating an assembly method for the braking mechanism.

FIG. 9 is a plan view of the manual feed feeding portion illustrating a state in which the braking mechanism is assembled.

Part (a) of FIG. 10 is a cross-sectional view illustrating the manual feed feeding portion in a state in which the cover is positioned at a closed position, and part (b) of FIG. 10 is a cross-sectional view illustrating a space in a right cover of a main assembly for accommodating the manual feed feeding portion.

FIG. 11 is a plan view of the manual feed feeding portion illustrating a positional relationship between a manual feed tray and the braking mechanism in the state in which the cover is positioned at the closed position.

FIG. 12 is a cross-sectional view illustrating the manual feed feeding portion in a state in which the cover is positioned at a midway position between the closed position and an open position.

Part (a) of FIG. 13 is a schematic view of the manual feed feeding portion in the state in which the cover is positioned at the midway position, and part (b) of FIG. 13 is a schematic view illustrating the braking mechanism and a groove cam in the state in which the cover is positioned at the midway position.

FIG. 14 is a cross sectional view illustrating the manual feed feeding portion in a state just before the cover is positioned at the open position.

FIG. 15 is a plan view of the manual feed feeding portion illustrating the positional relationship between the manual feed tray and the braking mechanism in the state just before the cover is positioned at the open position.

FIG. 16 is a graph view showing a relationship between an opening angle and moment of the cover.

FIG. 17 is a graph view showing transition of an angular speed at which the cover opens.

FIG. 18 is an exploded perspective view of a manual feed feeding portion illustrating a configuration of a braking mechanism in an Embodiment 2.

FIG. 19, part (a) and part (b), includes plan views of a manual feed feeding portion illustrating a positional relationship between a manual feed tray and the braking mechanism in the Embodiment 2.

FIG. 20, part (a), part (b) and part (c), includes perspective views of a portion of a manual feed tray illustrating procedures for assembling a braking mechanism to the manual feed tray in an Embodiment 3.

FIG. 21 is an exploded perspective view illustrating the manual feed tray, to which the braking mechanism is assembled, and a cover in the Embodiment 3.

FIG. 22, part (a) and part (b), includes plan views of a manual feed feeding portion illustrating a positional relationship between the manual feed tray and the braking mechanism in the Embodiment 3.

FIG. 23 is a schematic view to describe another Embodiment of the image forming apparatus.

FIG. 24 is a schematic view to describe another Embodiment of the image forming apparatus.

### DESCRIPTION OF THE EMBODIMENTS

Hereinafter, an image forming apparatus according to the present invention will be described in more detail with reference to the drawings.

### Embodiment 1

### Overall Configuration of an Image Forming Apparatus

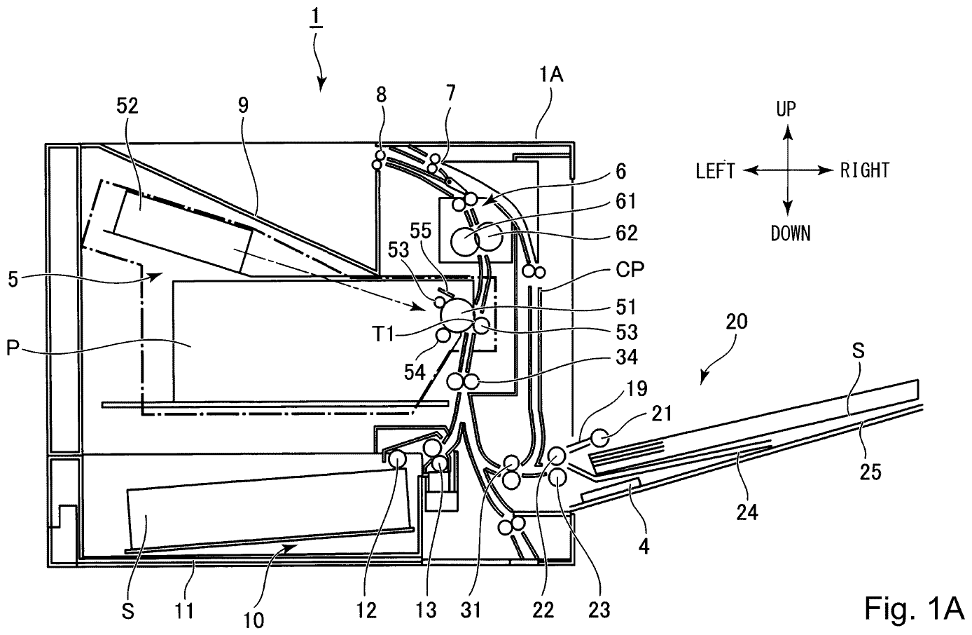

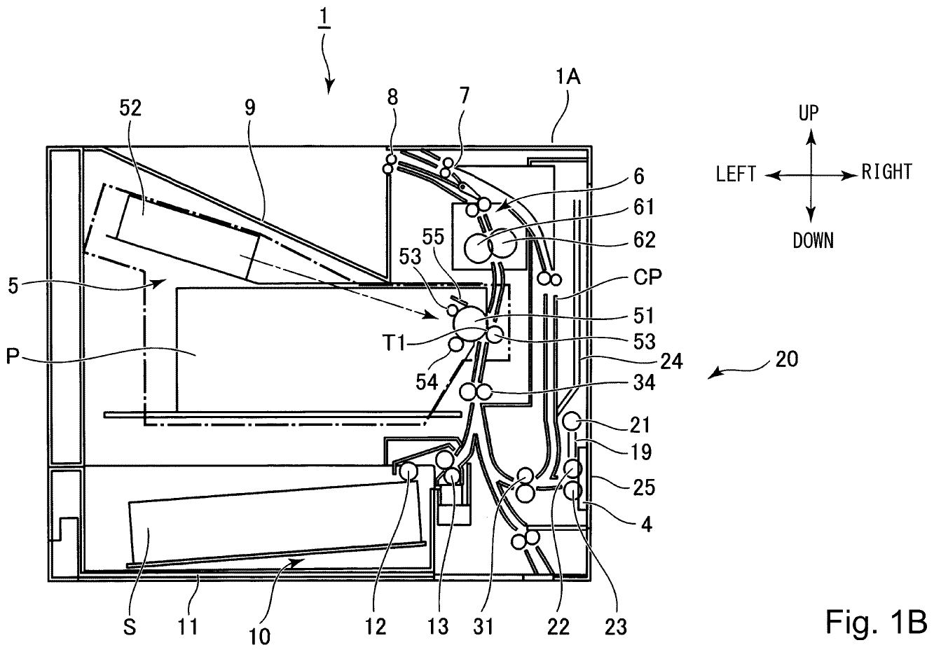

First, an overall configuration of an image forming apparatus in the present Embodiment will be described. FIG. 1A is a cross-sectional outline view of an image forming apparatus 1 in the present Embodiment. FIG. 1A shows a state in which a cover 25 of a manual feed feeding portion 20, which will be described below, is opened. The image forming apparatus 1 in the present Embodiment is a laser beam printer which forms a black monochrome image on a sheet S, which is a recording material having a sheet shape, using an electrophotographic type.

Incidentally, a near side of the paper of FIG. 1A will be referred to as a “front (front surface)” side, and a back side of the paper of FIG. 1A to a “back (back surface)” side. In other words, FIG. 1A shows the image forming apparatus 1 as viewed from the front side to the back side. When the image forming apparatus 1 is set and used on a horizontal plane, the front and back direction in FIG. 1A is parallel to the horizontal direction. The front and back direction is also parallel to a rotational axis direction of a photosensitive drum 51, which will be described below, and a swing axis direction of the cover 25 of the manual feed feeding portion 20, which will be described below. The sheet S is the recording material on which the image is formed by the image forming apparatus 1, and is, for example, a paper or an OHT sheet.

The image forming apparatus 1 includes a main assembly feeding portion 10 and the manual feed feeding portion 20, which feed the stacked sheet S. In addition, the image forming apparatus 1 includes an image forming portion 5, which forms the image on the sheet S fed by the main assembly feeding portion 10 or the manual feed feeding portion 20, a fixing device 6, which fixes the image transferred to the sheet S thereonto, and a discharging roller pair 8, which discharges the sheet S to a discharge tray 9.

When a print job is input to the image forming apparatus 1 from a host computer (not shown), which is connected to the image forming apparatus 1, based on image information included in the print job, image formation by the image forming portion 5 is started. The image forming portion 5 includes a laser scanner 52, a process cartridge P and a transfer roller 53. The process cartridge P includes the photosensitive drum 51, a charging roller 53, a developing roller 54 and a cleaning blade 55. The transfer roller 53 is pressed toward the photosensitive drum 51 to form a transfer nip (transfer portion) T1, which is a contact portion between the photosensitive drum 51 and the transfer roller 53. The photosensitive drum 51, which is an electrophotographic photosensitive member, rotates in a counterclockwise direction in FIG. 1A when an image forming process is started. The charging roller 53 uniformly charges a surface of the photosensitive drum 51. The laser scanner 52 irradiates the charged surface of the photosensitive drum 51 with a laser beam to form an electrostatic latent image on the photosensitive drum 51. The electrostatic latent image formed on the photosensitive drum 51 is developed by developer (toner) supplied by the developing roller 54, and a toner image is formed on the photosensitive drum 51.

In parallel with the image forming process described above, the sheet S is fed from the main assembly feeding portion 10 or the manual feed feeding portion 20. The main assembly feeding portion 10 includes a cassette 11, a feeding roller 12 as a feeding member, and a separating roller pair 13 as a separating member. The cassette 11 is a sheet accommodating portion, which can be drawn out from and inserted into a main assembly 1A of the image forming apparatus 1 (hereinafter, simply referred to as a “main assembly”). The sheets S accommodated in the cassette 11 are fed from the cassette 11 by the feeding roller 12. The sheets S fed from the cassette 11 by the feeding roller 12 are separated one by one by the separating roller pair 13.

The manual feed feeding portion 20 includes the cover 25 as an open/close portion, which is openably/closably supported by the main assembly 1A, and a manual feed tray 24 as a moving portion. The manual feed tray 24 is a supporting portion which supports the sheet S. In addition, the manual feed feeding portion 20 includes a feeding roller 21 and a feeding arm 19, which constitute a feeding portion, a conveyance roller 22, which is a conveyance portion, and a separating roller 23, which is a separating portion. The feeding roller 21 is supported by the feeding arm 19 rotatably and ascendably/descendably. The feeding arm 19 is rotatably supported by the main assembly 1A.

The sheets S supported by the manual feed tray 24 are fed from the manual feed tray 24 by the feeding roller 21. The sheets S fed from the manual feed tray 24 by the feeding roller 21 are separated one by one by the conveyance roller 22 and the separating roller 23. Details of a configuration of the manual feed feeding portion 20 will be described below.

The sheet S fed from the main assembly feeding portion 10 or the manual feed feeding portion 20 is conveyed to the transfer nip Tl by a convey ance roller pair (second conveyance roller pair) 34. The toner image formed on the photosensitive drum 51 is transferred, in the transfer nip T1, onto the sheet S nipped and conveyed by the photosensitive drum 51 and the transfer roller 53. The toner, which remains on the photosensitive drum 51 without being transferred to the sheet S, is removed from the photosensitive drum 51 by the cleaning blade 55 and collected.

The sheet S, onto which the toner image has been transferred, is conveyed to the fixing device 6 as a fixing means. The fixing device 6 applies a predetermined heat and pressure to the sheet S with a fixing film 61 and a pressing roller 62, and fixes (melts, sticks) the toner image onto the sheet S. The sheet S, which has passed through the fixing device 6, is discharged (output) onto the discharge tray 9 as a discharge portion by the discharging roller pair 8 as a discharging member.

In a case in which the images are formed on both sides of the sheet S, the sheet S, of which the image has been formed on a first side, is switched back by a reversing roller pair 7, and conveyed to a double-side conveyance path CP. The double-side convey ance path CP guides the sheet S toward a convey ance roller pair (first convey ance roller pair) 31. And the sheet S is again conveyed to the transfer nip T1 by the conveyance roller pairs 31 and 34, the toner image is transferred to a second side thereof in the transfer nip T1, and the toner image is fixed to the second side thereof by the fixing device 6. The sheet S, of which the images have been formed on the first side and the second side in this manner, is discharged to the discharge tray 9.

### Configuration of the Manual Feed Feeding Portion

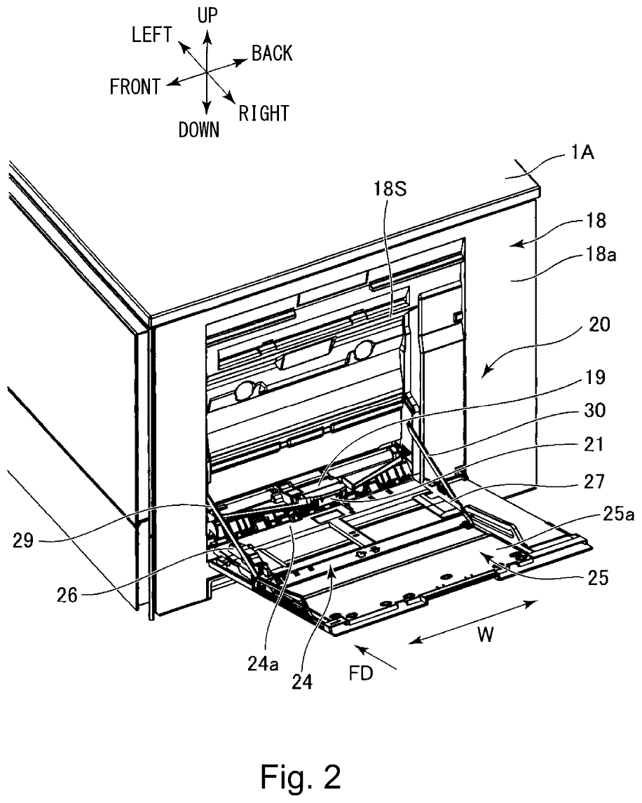

Next, the configuration of the manual feed feeding portion 20 in the present Embodiment will be described. FIG. 1B is a cross-sectional outline view of the image forming apparatus 1 illustrating a state in which the cover 25 of the manual feed feeding portion 20 is closed. FIG. 2 is a perspective view of a vicinity of a side surface on a right side of the image forming apparatus 1 illustrating the manual feed feeding portion 20. FIG. 2 shows a state in which the cover 25 of the manual feed feeding portion 20 is opened.

As shown in FIG. 2, the cover 25 as the open/close portion is openably/closably supported by a right cover 18 provided on the side surface on the right side of the main assembly 1A. The right cover 18 is a cover constituting a part of an exterior cover (housing) of the image forming apparatus 1, and constitutes the main assembly 1A. The cover 25 is openable and closable by being swung between a closed position (first position), at which the cover 25 is closed relative to the main assembly 1A (FIG. 1B), and an open position (second position), at which the cover 25 is opened relative to the main assembly 1A (FIG. 1A). By the cover 25, the manual feed tray 24, which is a sheet supporting member (sheet stacking member), as a moving portion is supported. The manual feed tray 24 supports the sheet S in a state in which the cover 25 is positioned at the open position. The manual feed tray 24 includes a supporting surface 24a as a sheet supporting portion (sheet stacking portion) for supporting the sheet S.

Here, a feeding direction (conveyance direction) of the sheet S from the manual feed feeding portion 20 (manual feed tray 24) may be simply referred to as a “feeding direction FD”, and is indicated by an arrow FD in FIG. 2. In addition, a direction of the sheet S supported on the manual feed feeding portion 20 (manual feed tray 24), which is approximately perpendicular to the feeding direction FD, may be simply referred to as a “widthwise direction W”, and is indicated by an arrow W in FIG. 2. The width wise direction W is approximately parallel to a rotational axis direction of the feeding roller 21.

The cover 25 is opened and closed, about a swing axis (rotational axis) located on a lower end portion side thereof when positioned at the closed position, so as an upper end portion side thereof when positioned at the closed position to be rotated, by being swung between the closed position and the open position. A swing axis direction of the cover 25 is a direction along (in the Embodiment, approximately parallel to) the widthwise direction W. The cover 25 is disposed so as to face a direction crossing the horizontal direction (in the present Embodiment, approximately extending in a vertical direction) when positioned at the open position, and is disposed so as to face a direction crossing the vertical direction (in the present Embodiment, extending in a direction inclined slightly above with respect to the horizontal direction) when positioned at the closed position. The manual feed feeding portion 20 is configured so that, in the state in which the cover 25 is positioned at the closed position, a configuration provided on an inner surface 25a side of the cover 25 is accommodated in an accommodating portion 18S, which is a space (recessed portion) provided in the right cover 18. In addition, the manual feed feeding portion 20 is configured so that, in the state in which the cover 25 is positioned at the closed position, an outer surface 18a of the right cover 18 and an outer surface 25d of the cover 25 (see part (a) of FIG. 10) are approximately flush with each other. In addition, to the right cover 18, a claw portion (not shown), which is engaged with the cover 25 to hold the cover 25 in the closed position, is provided.

The feeding roller 21 is configured, upon the print job causing the sheet S to be fed from the manual feed feeding portion 20 being input to the image forming apparatus 1, so as to be lowered by the feeding arm 19, and to contact an uppermost sheet S of the sheets S stacked on the manual feed tray 24. The feeding roller 21 contacts, by an urging mechanism (not shown), the sheet S stacked on the manual feed tray 24 with a predetermined pressure. In the present Embodiment, the feeding roller 21 is disposed at a position corresponding to approximately a center of the manual feed tray 24 in the widthwise direction W.

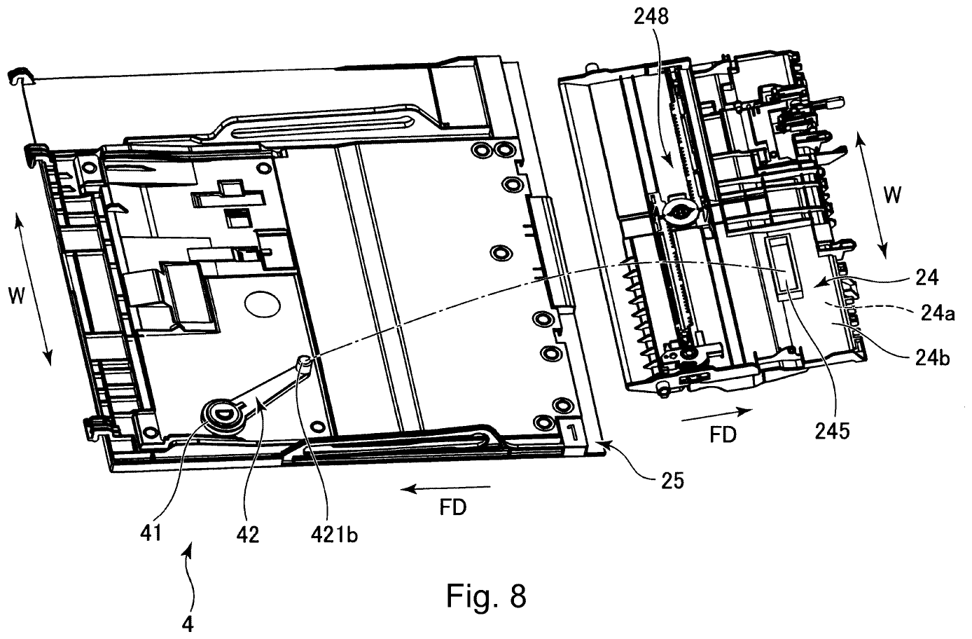

To the manual feed tray 24, a pair of side regulating plates 26 and 27 of the front side and the back side for regulating positions of both end portions in the widthwise direction W of the sheet S supported on the supporting surface 24a is provided. The side regulating plates 26 and 27 are supported by the manual feed tray 24 movably in the widthwise direction W. The side regulating plates 26 and 27 are movable because of a moving mechanism 248 (see FIG. 8) provided on the back surface 24b side, which is a surface on an opposite side to the supporting surface 24a, of the manual feed tray 24. The moving mechanism 248 may be constituted by, for example, a rack-and-pinion mechanism, which is configured so as the pair of the side regulating plates 26 and 27 to be moved approximately the same amount.

### Holding Configuration of the Manual Feed Tray

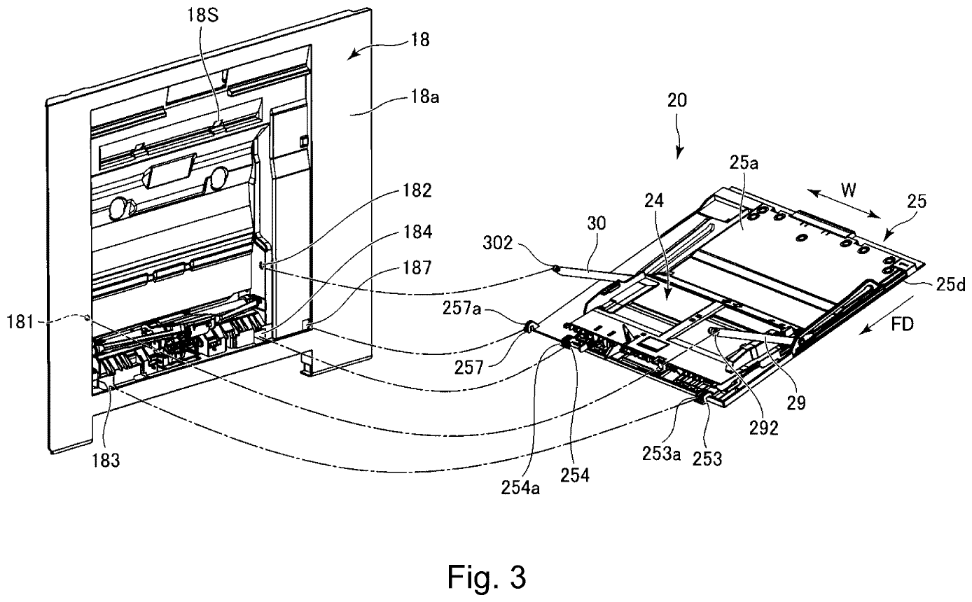

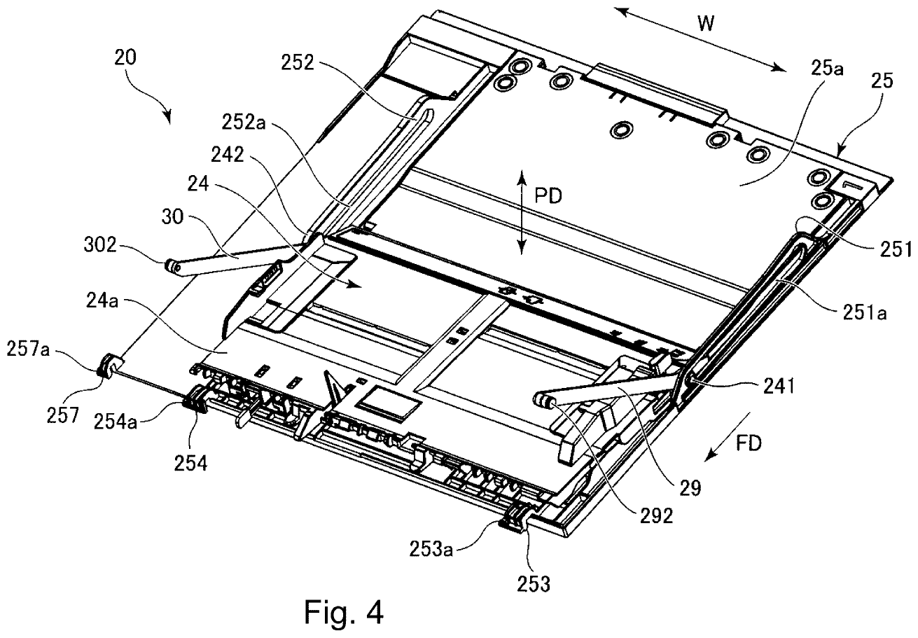

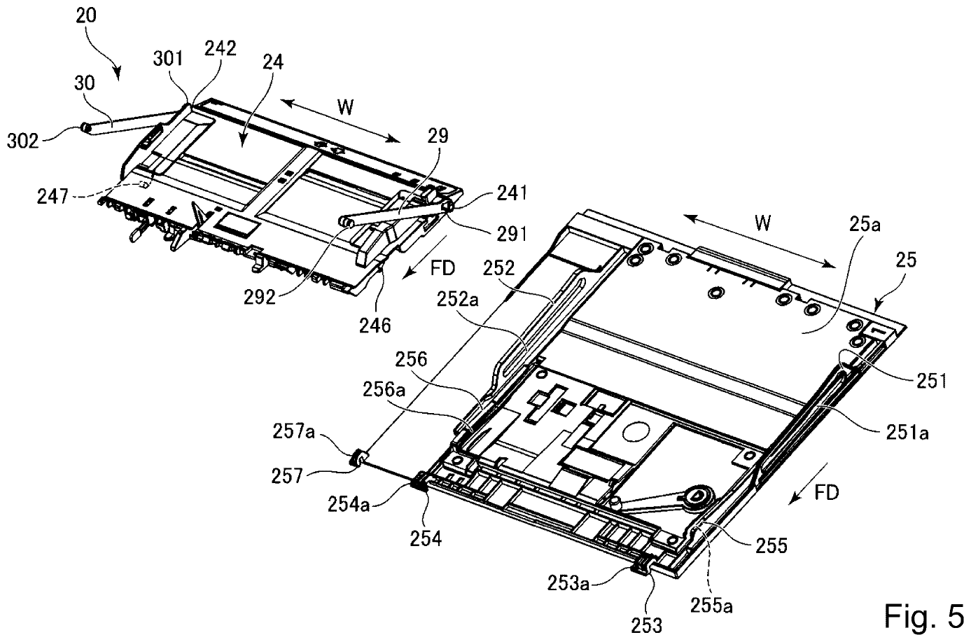

Next, a holding configuration of the manual feed tray 24 will be described. FIG. 3 is an exploded perspective view of the vicinity of the side surface on the right side of the image forming apparatus 1 illustrating the manual feed feeding portion 20. FIG. 4 is a perspective view of the manual feed feeding portion 20. In addition, FIG. 5 is an exploded perspective view of the manual feed feeding portion 20 illustrating a state in which the cover 25 and the manual feed tray 24 are exploded.

As shown in FIG. 3, to the right cover 18, a first, a second and a third cover engaging holes 183, 184 and 187, and a first and a second link engaging holes 181 and 182 are provided. The first, the second and the third cover engaging holes 183, 184 and 187 are provided to a lower end portion of the accommodating portion 18S of the right cover 18. The first and the third cover engaging holes 183 and 187 are provided to an end portion on the front side and an end portion on the back side of the accommodating portion 18S of the right cover 18, respectively. The second cover engaging hole 184 is provided between the first cover engaging hole 183 and the third cover engaging hole 187 (closer to the third cover engaging hole 187) in the front and back direction. The first and the second link engaging holes 181 and 182 are provided, above the first and the second cover engaging holes 183 and 184, respectively, at approximately the same position in the widthwise direction W as the first and the second cover engaging holes 183 and 184.

To the cover 25, a first, a second and a third projecting portions 253, 254 and 257, which are engageable with the first, the second and the third cover engaging holes 183, 184 and 187, are provided. To the first, the second and the third projecting portions 253, 254 and 257, a first, a second and a third rotation shafts 253a, 254a and 257a are provided, respectively. The cover 25 is supported by the main assembly 1A, in a state in which the respective projections 253, 254 and 257 are engaged with the respective cover engaging holes 183, 184 and 187, rotatably (swingably) about axes (swing axes) of the respective rotation shafts 253a, 254a and 257a, which are disposed coaxially with the projecting portions.

In addition, as shown in FIG. 4 and FIG. 5, the cover 25 includes, on one end portion side in the widthwise direction W (end portion side of the front side), a first upstream guide portion 251 and a first downstream guide portion 255. In addition, the cover 25 includes, on the other end portion side in the widthwise direction W (end portion side on the back side), a second upstream guide portion 252 and a second downstream guide portion 256. The first upstream guide portion 251 and the first downstream guide portion 255 are extended along (in the present Embodiment, approximately parallel to) the feeding direction FD, respectively, and at least a part of the first upstream guide portion 251 is disposed on an upstream side of the first downstream guide portion 255 in the feeding direction FD. In addition, the second upstream guide portion 252 and the second downstream guide portion 256 are extended along (in the present Embodiment, approximately parallel to) the feeding direction FD, and at least a part of the second upstream guide portion 252 is disposed on an upstream side of the second downstream guide portion 256 in the feeding direction FD.

In the first and the second upstream guide portions 251 and 252, a first and a second guide hole portions 251a and 252a, which are extending along (in the present Embodiment, approximately parallel to) the feeding direction FD, are formed, respectively. In addition, in the first and the second downstream guide portions 255 and 256, a first and a second guide grooves 255a and 256a, which are extending along (in the present Embodiment, approximately parallel to) the feeding direction FD, are formed, respectively.

The manual feed feeding portion 20 includes a first and a second tray links 29 and 30 as coupling members. The first and the second tray links 29 and 30 are disposed opposite to each other so as to put the manual feed tray 24 therebetween in the widthwise direction W. The first tray link 29 includes a first link supporting shaft 292 at one end portion thereof, and includes a first link hole portion 291 at the other end portion thereof. Similarly, the second tray link 30 includes a second link supporting shaft 302 at one end portion thereof, and includes a second link hole portion 301 at the other end portion thereof. The first link supporting shaft 292 is engageable with the first link engaging hole 181 (see FIG. 3) rotatably, and the second link supporting shaft 302 is engageable with the second link engaging hole 182 (see FIG. 3) rotatably. The first and the second tray links 29 and 30 are rotatably supported by the main assembly 1A by the first and the second link supporting shafts 292 and 302 being engaged with the first and the second link engaging holes 181 and 182 (see FIG. 3) of the right cover 18, respectively.

On the other hand, the manual feed tray 24 includes, at both end portions in the widthwise direction W (an end portion on the front side and an end portion on the back side), a first and a second supporting shafts 241 and 242, which are extended along (in the present Embodiment, approximately parallel to) the widthwise direction W toward an outside of the manual feed tray 24, respectively. The first and the second supporting shafts 241 and 242 are provided on both end portion sides of the manual feed tray 24 on the upstream side in the feeding direction FD. The first link hole portion 291 of the first tray link 29 is engageable with the first supporting shaft 241 rotatably, and the second link hole portion 301 of the second tray link 30 is engageable with the second supporting shaft 242 rotatably. In addition, the first supporting shaft 241 is engageable with the first guide hole portion 251a in a slidably movable manner, and the second supporting shaft 242 is engageable with the second guide hole portion 252a in a slidably movable manner. The first supporting shaft 241 penetrates the first link hole portion 291 of the first tray link 29, and is engaged with the first guide hole portion 251a provided to the first upstream guide portion 251 of the cover 25. The second supporting shaft 242 penetrates the second link hole portion 301 of the second tray link 30, and is engaged with the second guide hole portion 252a provided to the second upstream guide portion 252 of the cover 25. In other words, the first and the second link hole portions 291 and 301 are engageable (couplable), via the first and the second supporting shafts 241 and 242, respectively, with the first and the second guide hole portions 251a and 252a in the slidably movable manner.

The first and the second supporting shafts 241 and 242 are movable along the first and the second guide hole portions 251 a and 252a, respectively. As the cover 25 is opened and closed, the first and the second supporting shafts 241 and 242 moves within the first and the second guide hole portions 251a and 252a. As a result, in interrelation with the first and the second supporting shafts 241 and 242, the manual feed tray 24 slides and moves in a direction along (in the Embodiment, approximately parallel to) the inner surface (upper surface in FIG. 4) 25a of the cover 25. In other words, the cover 25 supports the manual feed tray 24 movably in a direction along (in the present Embodiment, approximately parallel to) the supporting surface 24a. In other words, the first and the second tray links 29 and 30 causes the manual feed tray 24 to move in the direction along the supporting surface 24a in interrelation with the opening and closing of the cover 25. In this manner, the manual feed tray 24 is an example of the moving portion coupled with the cover (open/close portion) 25 and configured to move relative to both the main assembly 1A and the cover 25 with the rotation of the cover 25. Here, the moving portion may be coupled with the open/close portion by being directly connected to the open/close portion, or may be coupled with the open/close portion by being indirectly connected to the open/close portion via another member. A moving direction of the manual feed tray 24 is a direction along (in the present Embodiment, approximately parallel to) the feeding direction FD. When the cover 25 moves from the closed position toward the open position, the manual feed tray 24 moves from the upstream side to a downstream side in the feeding direction FD. In other words, upon this, the manual feed tray 24 moves so as to get closer to the swing axis of the cover 25. In addition, upon the cover 25 moving from the open position toward the closed position, the manual feed tray 24 moves from the downstream side to the upstream side in the feeding direction FD. In other words, the manual feed tray 24 moves so as to go away from the swing axis of the cover 25. Hereinafter, the moving direction of the manual feed tray 24 upon the cover 25 moving from the closed position to the open position is also referred to simply as a “moving direction FD”.

When the cover 25 is positioned at the closed position, the manual feed tray 24 is positioned at an accommodated position (third position), which is a position on an end portion side on the upstream side in the feeding direction FD on the cover 25. In addition, when the cover 25 is positioned at the open position, the manual feed tray 24 is positioned at a feeding position (fourth position), which is a position on an end portion side on the downstream side in the feeding direction FD on the cover 25 and a position at which the sheet S stacked on the manual feed tray 24 can be fed.

In addition, as shown in FIG. 5, to both end portions in the widthwise direction W of the manual feed tray 24 (the end portion on the front side and the end portion on the back side), a first and a second guide pins 246 and 247 are provided. The first and the second guide pins 246 and 247 are engageable with a first and a second guide grooves 255a and 256a, which are formed in the first and the second downstream guide portions 255 and 256 of the cover 25, respectively, in a slidably movable manner. The first and the second guide pins 246 and 247 are projected toward the outside of the manual feed tray 24 (downward in FIG. 5) along a direction crossing (in the present Embodiment, approximately perpendicular to) a surface direction of the supporting surface 24a, and are projected toward the outside of the manual feed tray 24 along the widthwise direction W, respectively. The first and the second guide pins 246 and 247 are engaged with the first and the second guide grooves 255a and 256a formed in the first and the second downstream guide portions 255 and 256 of the cover 25, respectively. By this, it becomes possible, upon the cover 25 being rotated, to restrict the manual feed tray 24 from being lifted in a stacking direction of the sheets S with respect to the cover 25, and suppress the manual feed tray 24 from making noise by contacting the cover 25. In other words, in the manual feed tray 24, by the first and the second guide pins 246 and 247 being engaged with the first and the second guide grooves 255a and 256a, in a normal direction PD of the supporting surface 24a of the manual feed tray 24 (the inner surface 25a of the cover 25), a position thereof is restricted.

In the present Embodiment, the first and the second tray links 29 and 30 are configured to have substantially the same configuration. In addition, in the present Embodiment, the first and the second upstream guide portions 251 and 252 are configured to have substantially the same configuration. The first and the second link supporting shafts 292 and 302 constitute first engaging portions (first coupling portions) which are rotatably engageable (couplable) with the main assembly 1A, respectively. In addition, the first and the second link hole portions 291 and 301 constitute second engaging portions (second coupling portions) which are engageable (couplable) with the cover 25 in a slidably movable manner, respectively.

Incidentally, it may be configured that to the image forming apparatus 1, at least one coupling member, which causes the moving portion relative to move with respect to the open/close portion in interrelation with the swing of the open/close portion, is provided.

A user (an operator) can, for example, upon using the manual feed feeding portion 20, open the cover 25 by moving the cover 25 from the closed position to the open position. In the present Embodiment, the cover 25 is configured to be openable and closable by the user operating the cover 25 with his/her hand. In addition, in the present Embodiment, after the movement from the closed position to the open position is started by the operation by the user, even when the user removes his/her hand from the cover 25 before reaching the open position, the cover 25 can move to the open position due to own weight thereof, etc. without the operation by the user. As such, the cover 25 is an example of the open/close portion which takes an open state in which the open/close portion is open relative to the main assembly 1A and a closed state in which the open/close portion is closed relative to the main assembly 1A. In the present Embodiment, the cover 25 is the open/close portion shifting from the closed state to the open state by rotating relative to the main assembly 1A due to its own weight. However, as described below, the open/close portion may be an open/close portion shifting from the open state to the closed state by rotating relative to the main assembly 1A due to its own weight. In other words, the cover 25 is an example of the open/close portion shifting from one state of the open state and the closed state to the other state by rotating relative to the main assembly 1A due to its own weight.

The manual feed feeding portion 20 includes a braking mechanism 4 as a braking means to reduce a speed upon the cover 25 opening due to own weight thereof, etc. without the operation by the user. The braking mechanism 4 applies a load which suppresses the movement of the cover 25 from the closed position toward the open position. In the present Embodiment, the braking mechanism 4 is provided to the cover 25.

Here, there is a case in which it is desirable to change a braking force applied to the cover 25 during the cover 25 moving from the closed position to the open position. For example, there is a case in which, in order to smooth an initial motion of the movement from the closed position to the open position and appropriately reduce impact upon having moved to the open position, it is desirable for the braking force applied to the cover 25, before the cover 25 reaches the open position, to be changed so as to be increased. Therefore, it is desirable to increase, while suppressing an increase in a size of the apparatus, a degree of freedom in the control of the braking force applied to the open/close portion.

### Configuration of the Braking Mechanism

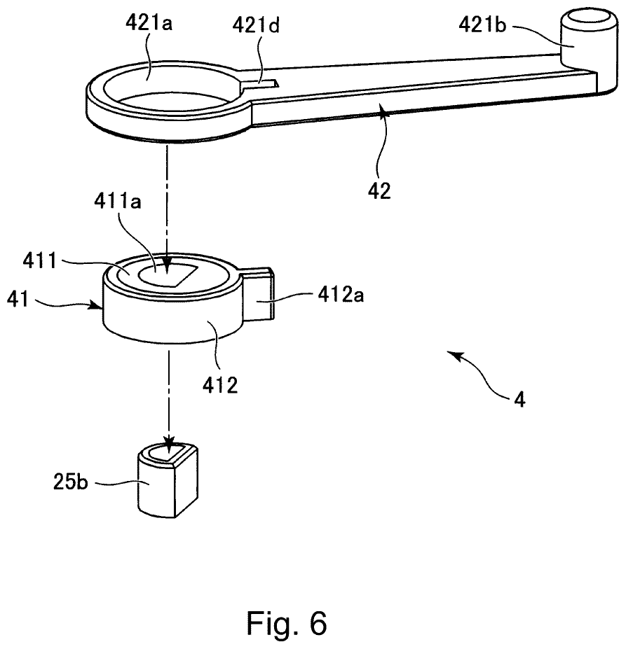

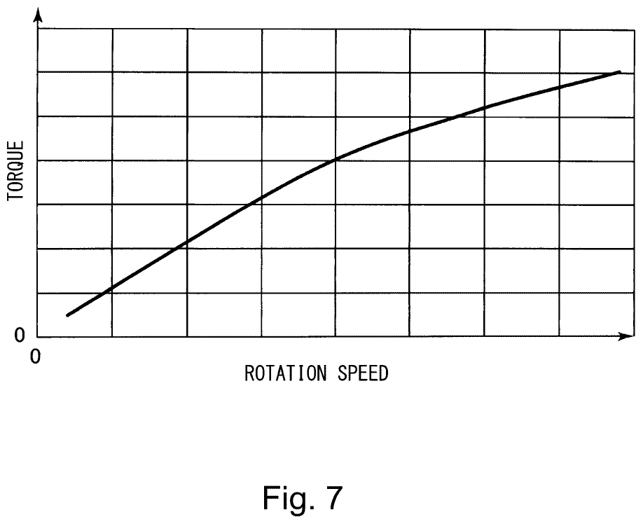

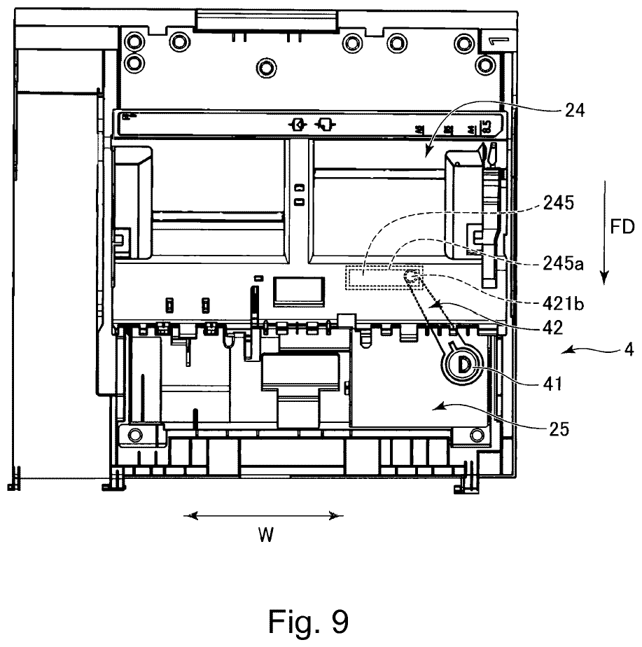

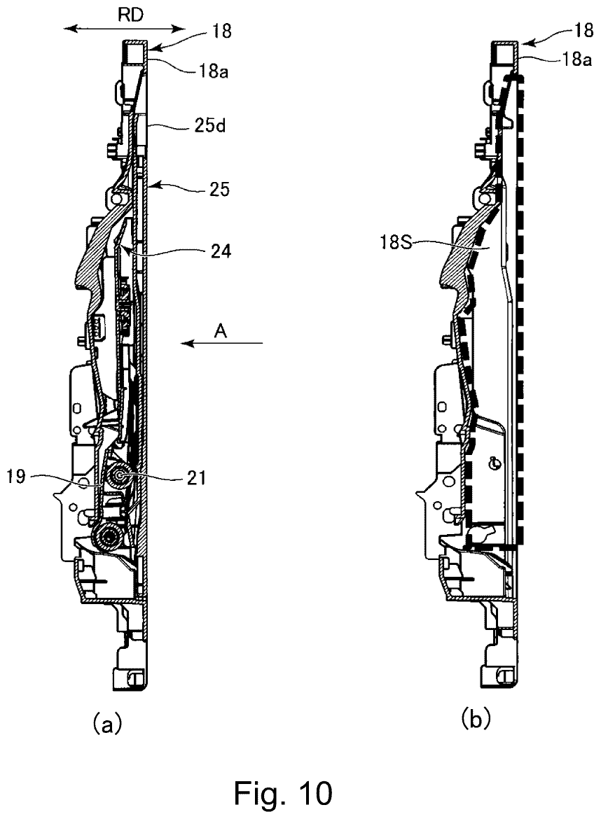

Next, a configuration of the braking mechanism 4 in the present Embodiment will be described. FIG. 6 is an exploded perspective view of the braking mechanism 4. FIG. 7 is a graph view showing a relationship between a rotation speed and torque of the braking mechanism 4. FIG. 8 is an exploded perspective view of the manual feed feeding portion 20 illustrating an assembly method of the braking mechanism 4. FIG. 9 is a plan view of the manual feed feeding portion 20 illustrating a state in which the braking mechanism 4 is assembled.

As shown in FIG. 6, the braking mechanism 4 is configured to include an oil damper 41, which constitutes a braking force generating portion, and an arm 42.

The oil damper 41 is an example of a damper which generates the braking force for braking the cover (open/close portion) 25 by moving with the movement of the manual feed tray (moving portion) 24. The oil damper 41 is configured to include a fixing portion 411 and a rotatable portion 412 rotatably provided on the fixing portion 411 coaxially. Between the fixing portion 411 and the rotatable portion 412, a predetermined gap (not shown) is formed, and oil such as silicone oil as working fluid (braking force generating medium) is sealed in the gap. By this, the oil damper 41 generates the braking force. In the fixing portion 411, a fixing hole 41 la of which a cross section approximately perpendicular to a rotational axis direction of the rotatable portion 412 has a D-shape. To the rotatable portion 412, in a part of an outer peripheral surface thereof in a peripheral direction, a projecting portion 412a is formed so as to be projecting along a rotational radial direction of the rotatable portion 412.

In the inner surface 25a of the cover 25, so as to be projecting toward the manual feed tray 24 side in a direction crossing (in the present Embodiment, approximately perpendicular to) a surface direction of the inner surface 25a, a damper shaft 25b of which a cross section along (in the present Embodiment, approximately parallel to) the inner surface 25a has the D-shape is formed. The oil damper 41 is installed to the cover 25 by the damper shaft 25b formed in the cover 25 being inserted into the fixing hole 411a formed in the fixing portion 411. The rotational axis direction of the rotatable portion 412 (a swing axis direction of the arm 42) is a direction crossing (in the present Embodiment, approximately perpendicular to) the surface direction of the inner surface 25a of the cover 25. In other words, the arm 42 is swingable (rotatable) along the surface direction of the inner surface 25a of the cover 25. The braking mechanism 4 having the configuration in this manner has a higher degree of freedom in disposition compared to a braking mechanism disposed coaxially with the swing axis of the cover 25, etc.

The arm 42 is an example of a first transmitting portion coupled with the oil damper (damper) 41 and a first transmitting portion which transmits the braking force. Here, the first transmitting portion may be coupled with the damper by being directly connected to the damper, or may be coupled with the damper by being indirectly connected to the damper via another member. In one end portion (base end portion) of the arm 42, a hole portion 421a, which serves as a swing center (rotation center) of the arm 42, is formed. In the hole portion 421a, in a part of an inner peripheral surface thereof in a peripheral direction, a groove 421d, into which the projecting portion 412a formed in the rotatable portion 412 is inserted, is formed. The arm 42 is attached, so as the projecting portion 412a of the rotatable portion 412 to be aligned with the groove 421d of the hole portion 421a, by the inner peripheral surface of the hole portion 421a being inserted (fitted) into the outer peripheral surface of the rotatable portion 412, to the oil damper 41. The arm 42 is extended, in a state of being attached to the oil damper 41, along the rotational radial direction of the rotatable portion 412. In addition, to the other end portion (a leading end portion) of the arm 42, an engaging shaft 421b as a contacting portion contactable to (engageable with) the manual feed tray 24 is provided. The engaging shaft 421b is projected, along (in the present Embodiment, approximately parallel to) the rotational axis direction of the rotatable portion 412, from the arm 42 toward the manual feed tray 24 side. In the present Embodiment, the engaging shaft 421b is formed integrally with the arm 42.

Incidentally, the rotatable portion 412 and the arm 42 may be integrally formed. In addition, the oil damper 41 need not be disposed at the swing center of the arm 42. For example, it may be configured that an oil damper, in which a gear is formed on an outer peripheral surface of the rotatable portion 412, and a gear, which is formed on an inner peripheral surface of the swing center of the arm so as to be meshed with the gear of the oil damper, are meshed with each other. In addition, between the arm 42 and the oil damper 41, another member such as a gear, which transmits the movement of the arm 42 to the oil damper 41 (i.e., transmits the load of the oil damper 41 to the arm 42), may be provided. In addition, an arrangement relationship of the fixing hole 411a and the damper shaft 25b in the fixing portion 411 and the cover 25, respectively may be opposite to that in the present Embodiment. For example, it may be configured that a projection such as a shaft is provided to the fixing portion 411 and a hole or a recessed portion is formed in the cover 25. In addition, a fixing method of the fixing portion 411 is not limited to by engagement between a projection such as a shaft and a hole or a recessed portion, but the fixed portion 411 may be fixed by any fixing means such as adhesion, welding and fastening. In addition, the contacting portion, which transmits the braking force from the oil damper 41 to the manual feed tray 24 by being in contact (engaged) with the manual feed tray 24, such as the engaging shaft 421b may be constituted by a different member, which is held by the arm 42, from the arm 42 such as a roller or a shaft rotatably supported by the arm 42.

The oil damper 41 has speed dependency, and torque thereof is changed depending on a rotation speed (relative speed) of the rotatable portion 412 relative to the fixing portion 411. In other words, in the oil damper 41, depending on the rotation speed (relative speed) of the rotatable portion 412 relative to the fixing portion 411, the braking force (load) generated (supplied) is changed. FIG. 7 shows results from measurement of a relationship between the rotation speed and the torque of the oil damper 41 filled with silicone oil in the present Embodiment under a normal temperature (23° C.) environment. As shown in FIG. 7, in the oil damper 41, as the rotation speed of the rotatable portion 412 relative to the fixing portion 411 increases, the torque increases. In this manner, in the present Embodiment, as a moving speed of the oil damper (damper) 41 increases, the braking force generated by the oil damper (damper) 41 becomes large.

As shown in FIG. 8, a groove cam 245 as a speed reduction ratio changing means is formed on the back surface 24b, which is the surface on the opposite side to the supporting surface 24a, of the manual feed tray 24. In the present Embodiment, the groove cam 245 has a rectangular shape in a planar view. That is, the groove cam 245 includes a long wall portion extending along (in the present Embodiment, approximately parallel to) the widthwise direction W and a short wall portion extending along (in the present Embodiment, approximately parallel to) the feeding direction FD, each projecting toward the cover 25 side along a direction crossing (in the present Embodiment, approximately perpendicular to) a surface direction of the back surface 24b. Upon assembling the manual feed tray 24 to the cover 25, the engaging shaft 421b fixed to the arm 42 is inserted into the groove cam 245. FIG. 9 shows the cover 25, the manual feed tray 24 and the braking mechanism 4 in a state in which the assembly of the manual feed tray 24 to the cover 25 is completed and the cover 25 is positioned at the closed position. As shown in FIG. 9, upon being inserted into the groove cam 245, the engaging shaft 421b of the braking mechanism 4 is contactable to (engageable with) a contacting surface (a side surface of the long wall portion on an upstream side in the feeding direction FD) 245a provided in the groove cam 245. Upon the cover 25 moves from the closed position to the open position, the engaging shaft 421b of the moving mechanism 4 is in contact (engaged) with the contacting surface 245a of the groove cam 245. The contacting surface 245a is an example of a second transmitting portion to which the braking force for braking the cover (open/close portion) 25 is transmitted from the arm 42 by being in contact with the arm (first transmitting portion) 42, and a second transmitting portion which transmits the braking force to the cover (open/close portion) 25.

Upon the cover 25 moves from the closed position to the open position, the braking force generated by the oil damper 41 is transmitted, via the engaging shaft 421b formed in the arm 42 and the contacting surface 245a of the groove cam 245 formed in the manual feed tray 24, to the manual feed tray 24. The manual feed tray 24 is configured so as to slide and move with respect to the cover 25 in interrelation with the opening and closing of the cover 25 by the first and the second tray links 29 and 30. Therefore, the braking force transmitted to the manual feed tray 24 is transmitted to the cover 25 via the first and the second tray links 29 and 30.

### Opening Operation of the Cover

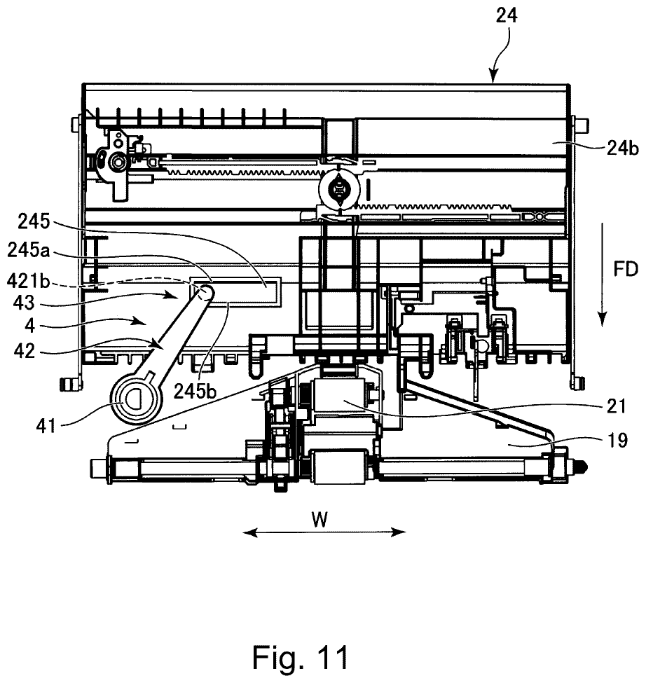

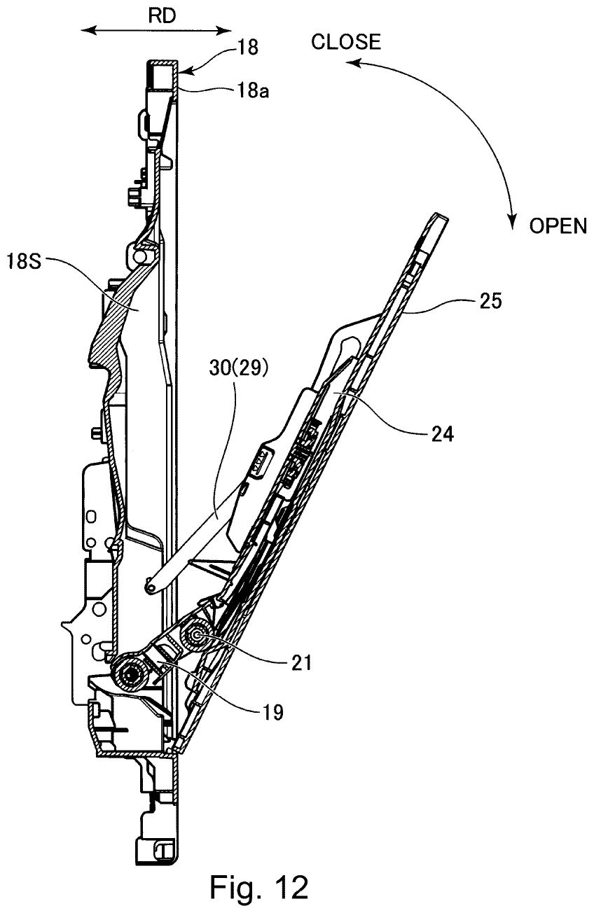

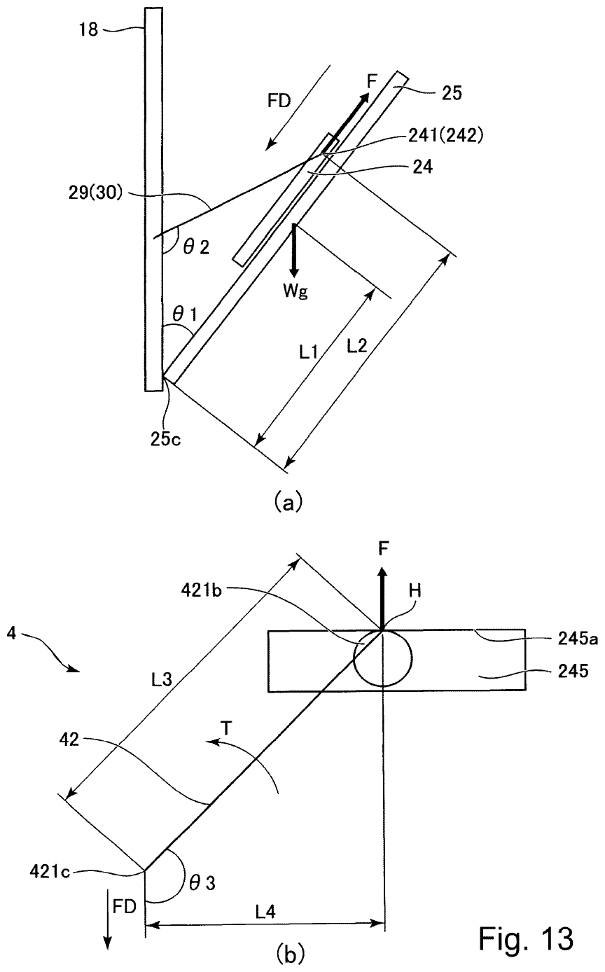

Next, upon opening the cover 25, movement of each member will be described. Part (a) of FIG. 10 is a cross-sectional view illustrating the manual feed feeding portion 20 in a state in which the cover 25 is positioned at the closed position (illustrates a cross section of the manual feed feeding portion 20 approximately perpendicular to the swing axis direction of the cover 25). Part (b) of FIG. 10 is a cross-sectional view illustrating the accommo dating portion 18S, which is the space for accommodating the manual feed feeding portion 20 in the right cover 18 of the main assembly 1A (illustrates a cross section of the accommodating portion 18S approximately perpendicular to the swing axis of the cover 25). FIG. 11 is a plan view of the manual feed feeding portion 20 illustrating a positional relationship between the manual feed tray 24 and the braking mechanism 4 in the state in which the cover 25 is positioned at the closed position (illustrates a state as viewed in approximately parallel to the swing axis direction of the arm 42. In addition, Illustration of the cover 25 is omitted.). FIG. 12 is a cross-sectional view illustrating the manual feed feeding portion 20 in the state in which the cover 25 is positioned at a midway position between the closed position and the open position (illustrates a cross section of the manual feed feeding portion 20 approximately perpendicular to the swing axis direction of the cover 25).

As shown in part (a) of FIG. 10, in the state in which the cover 25 is positioned at the closed position, the feeding arm 19, the feeding roller 21 and the manual feed tray 24 are accommodated in the accommodating portion 18S of the right cover 18 indicated by a broken line in part (b) of FIG. 10. In the state in which the cover 25 is positioned at the closed position, by the holding configuration of the manual feed tray 24 described above, the manual feed tray 24 is positioned on an end portion side on an upper side in the accommodating portion 18S. In addition, in this state, the feeding arm 19 and the feeding roller 21 are positioned on an end portion side on a lower side in the accommodating portion 18S.

FIG. 11 illustrates a state, in which the illustration of the cover 25 is omitted and the manual feed feeding portion 20 is viewed from an outside of the cover 25 (in a direction of an arrow A in part (a) of FIG. 10) in a left and right direction RD (see part (a) of FIG. 10). The left and right direction RD is a direction approximately perpendicular to a surface direction of the outer surface 18a of the right cover 18. As shown in FIG. 11, the braking mechanism 4 is disposed, in the widthwise direction W (rotational axis direction of the feeding roller 21), at a shifted position with respect to the feeding arm 19 and the feeding roller 21.

By arranging as described above, in the state in which the cover 25 is positioned at the closed position, the feeding arm 19 and the feeding roller 21 and the braking mechanism 4 are not overlapped with each other in the left and right direction RD. In addition, in this state, the feeding arm 19 and the feeding roller 21 and the manual feed tray 24 are not overlapped with each other in the left and right direction RD. In addition, in this state, the oil damper 41 of the braking mechanism 4 and the manual feed tray 24 are not overlapped with each other in the left and right direction RD. Therefore, it becomes possible to arrange the manual feed tray 24, the feeding arm 19, the feeding roller 21 and the braking mechanism 4 compactly in the manual feed feeding portion 20.

In addition, as shown in FIG. 11, in the state in which the cover 25 is positioned at the closed position, the arm 42 of the braking mechanism 4 and the groove cam 245 formed in the manual feed tray 24 are positioned at positions shown in FIG. 11, respectively. In other words, in the state in which the cover 25 is positioned at the closed position, so as an arm angle θ3, which will be described below, to be 90°<θ3<180°, the arm 42 is disposed with inclined to the moving direction FD so that the arm 42 faces an upstream side of the moving direction FD of the manual feed tray 24. In addition, in this state, the engaging shaft 421b is in a state of being disposed on an end portion side on the front side of the groove cam 245. In addition, in this state, the feeding roller 21 is urged to the cover 25 side by the urging mechanism (not shown).

In the state in which the cover 25 is positioned at the closed position, by the operation by the user, when the engagement between the claw portion (not shown) provided to the right cover 18 and the cover 25 is released, the cover 25 begins to open in a clockwise direction (a direction of an arrow OPEN) in FIG. 12. In other words, the movement of the cover 25 from the closed position to the open position starts. Upon this, since the urging force is applied to the feeding roller 21 in the clockwise direction in FIG. 12, the feeding roller 21 also applies a load to the cover 25 in a direction opening the cover 25 (the direction of the arrow OPEN).

As shown in FIG. 12, in the state in which the cover 25 is positioned at the midway position between the closed position and the open position, at which the cover 25 is opened by a predetermined amount from the closed position, the manual feed tray 24 is positioned, by the actions by the first and the second tray links 29 and 30, between the accommodated position and the feeding position.

Part (a) of FIG. 13 is a schematic view illustrating the manual feed feeding portion 20 in the state in which the cover 25 is positioned at the midway position as in FIG. 12 (illustrates a state as viewed in approximately parallel to the swing axis direction of the cover 25). Part (a) of FIG. 13 schematically illustrates a load applied to the cover 25 at the midway position. As shown in part (a) of FIG. 13, to the cover 25, own weight (Wg) is applied downward in the vertical direction at a position of a center of gravity (a distance L1 from a rotation center (swing axis) 25c of the cover 25). This own weight acts as a moment in the direction in which the cover 25 opens. Incidentally, for the sake of description, it is assumed that the manual feed tray 24 is sufficiently light relative to the cover 25. In addition, to the manual feed tray 24, a load F by the braking mechanism 4 described above is applied in a direction opposite to the moving direction FD of the manual feed tray 24. The load F acts, by the first and the second supporting shafts 241 and 242 of the manual feed tray 24 and the first and the second tray links 29 and 30, as a moment in a direction in which the cover 25 is closed. An angle (“opening angle”) of the cover 25 with respect to the surface direction of the right cover 18 (in the present Embodiment, approximately the vertical direction) is defined as θ1, and an angle (“link angle”) of the first and the second tray links 29 and 30 with respect to the surface direction of the right cover 18 is defined as θ2. In addition, a distance from the rotation center 25c of the cover 25 to the first and the second supporting shafts 241 and 242 is defined as L2. When it is assumed that loads due to frictions in the engaging portions between each member is sufficiently small compared to the loads due to own weight and the braking mechanism 4, a moment M of a force applied to the cover 25 can be expressed by the following Equation (1).

[Equation 1]

MM=WWWW×LL1×sinθθ1−FF×LL2×cos(θθ1+θθ2−90)×cos(180−θθ1−θθ2) (1)

Here, a moment in a clockwise direction in part (a) of FIG. 13 (the direction in which the cover 25 opens) is defined as positive (+). In a case in which the moment M applied to the cover 25 is positive (+), the moment due to own weight of the cover 25 becomes larger than the moment due to the load F by the braking mechanism 4 (the moment which the cover 25 receives from the braking mechanism 4), so that the cover 25 opens due to own weight thereof. On the other hand, in a case in which the moment M applied to the cover 25 is negative (−), the moment due to own weight of the cover 25 becomes smaller than the moment due to the load F by the braking mechanism 4, so that the cover 25 stops.

Part (b) of FIG. 13 is a schematic view illustrating the braking mechanism 4 and the groove cam 245 in the state in which the cover 25 is positioned at the midway position as in FIG. 12 (illustrates a state as viewed in approximately parallel to the swing axis direction of the arm 42). Part (b) of FIG. 13 schematically illustrates a moment of a force of the braking mechanism 4. When the torque of the oil damper 41 is defined as T and the rotation speed of the arm 42, which moves with the opening operation of the cover 25, is defined as N, the torque T is a function of the rotation speed N, so that the torque T can be expressed by the following Equation (2).

Incidentally, the rotation speed N of the arm 42 correlates with an angular speed at which the cover 25 opens.

[Equation 2]

TT=ff(NN) (2)

A distance from a swing center (swing axis) 421c of the arm 42 to a contacting position (contacting point) H between the engaging shaft 421b and the contacting surface 245a is defined as L3. In addition, an angle (the “arm angle”) between the moving direction FD of the manual feed tray 24 and a straight line connecting the swing center 421c of the arm 42 and the contacting position H described above is defined as θ3. In this case, the load F due to the braking mechanism 4, which is applied to the manual feed tray 24, can be expressed by the following Equation (3).

$$[ Equation 3 ]$$

$$FF = \frac{ff ( NN )}{LL 3 \times cos ( \vert θθ 3 - 90 \vert )} \qquad ( 3 )$$

According to the Equation (3), the load F due to the braking mechanism 4 is changed, in addition to the torque T of the oil damper 41, depending on the arm angle θ3. In addition, according to the Equation (3), in the process in which the cover 25 opens, when θ3=90°, the load F due to the braking mechanism 4 becomes smallest.

As shown in part (a) and part (b) of FIG. 13, the link angle θ2 and the arm angle θ3 are functions of the opening angle θ1 of the cover 25 as θ2=f(θ1) and θ3=f(θ1). Therefore, using the Equation (1) and the Equation (3), from the opening angle θ1 of the cover 25, the load F due to the braking mechanism 4, which is applied to the cover 25, and the moment M applied to the cover 25 can be obtained. Incidentally, in the state shown in part (b) of FIG. 13, the arm 42 is disposed, so as the arm angle θ3 to be 90°<θ3<180° (provided, θ3 is smaller than when the cover 25 is positioned at the closed position), with inclined to the moving direction FD so that the arm 42 faces the upstream side of the moving direction FD of the manual feed tray 24. In addition, in this state, the engaging shaft 421b is in a state of being disposed between the end portion on the front side and an end portion on the back side of the groove cam 245 (provided, more on the end portion side of the back side than when the cover 25 is positioned at the closed position). In the process of the cover 25 moving from the closed position to the open position, when θ3=90°, the engaging shaft 421b is disposed most on the end portion side of the back side in the groove cam 245. In other words, in the process of the cover moving from the closed position to the open position, when θ3=90°, a distance L4 from the swing center 421c of the arm 42 to the contacting position H described above in a direction approximately perpendicular to the moving direction FD of the manual feed tray 24 becomes largest.

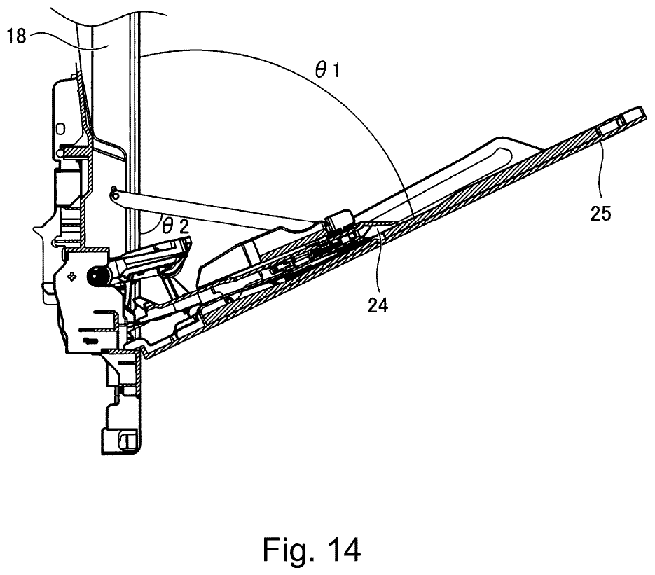

FIG. 14 is a cross sectional view illustrating the manual feed feeding portion 20 in a state just before the cover 25 is positioned at the open position. In the state shown in FIG. 14, the opening angle θ1 of the cover 25 becomes larger than in the state shown in FIG. 12. Therefore, in the state shown in FIG. 14, a value of sinθ1 in the Equation (1) becomes larger than in the state shown in FIG. 12, so that the moment due to own weight of the cover 25 becomes larger. Therefore, in the state shown in FIG. 14, than the state shown in FIG. 12, a speed at which the cover 25 opens, i.e., the rotation speed of the arm 42 becomes faster, so that the torque T of the oil damper 41 becomes larger.

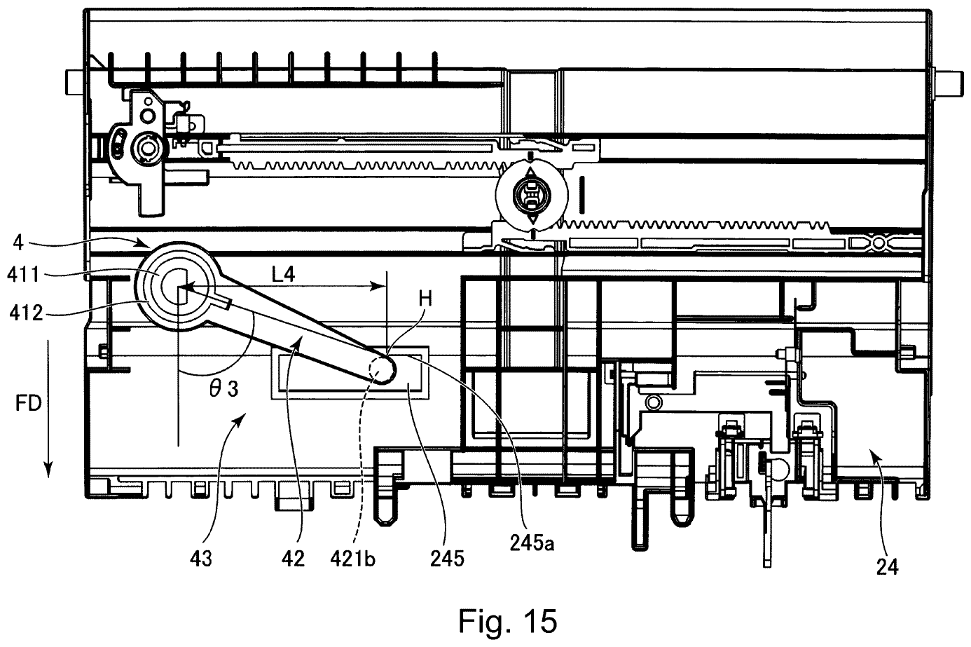

In addition, FIG. 15 is a plan view of the manual feed feeding portion 20 illustrating the positional relationship between the manual feed tray 24 and the braking mechanism 4 in the state just before the cover 25 is positioned at the open position (illustrates a state as viewed in approximately parallel to the swing axis direction of the arm 42. In addition, illustration of the cover 25 is omitted.). In the state shown in FIG. 15, the arm angle θ3 becomes smaller than the state shown in part (b) of FIG. 13, and 0°<θ3<90°. Therefore, according to the Equation (3), in the state shown in FIG. 15, than the state shown in part (b) of FIG. 13, the load F due to the torque T of the oil damper 41 (the load F due to the braking mechanism 4) becomes larger.

Incidentally, in the state shown in FIG. 15, so that 0°<θ3<180°, the arm 42 is disposed with inclined to the moving direction FD so that the arm 42 faces a downstream side in the moving direction FD of the manual feed tray 24. In addition, in this state, the engaging shaft 421b is in a state of being disposed between the end portion on the front side and the end portion on the back side of the groove cam 245 (provided, more on the end portion side of the front side than when θ3=90°). In other words, the distance L4 from the swing center 421c of the arm 42 to the contacting position H described above in the direction approximately perpendicular to the moving direction FD of the manual feed tray 24 becomes smaller than when θ3=90°.

In this manner, in the present Embodiment, the braking force transmitting mechanism 43 as a braking force transmitting means is configured to include the arm 42, of which the engaging shaft 421b is formed in the leading end portion, and the groove cam 245 (contacting surface 245a) formed in the manual feed tray 24. The braking force transmitting mechanism 43 is capable of transmitting, with changing depending on the opening angle of the cover 25, the braking force from the oil damper 41 to the manual feed tray 24. In the present Embodiment, the braking force transmitting mechanism 43 is configured so as to take, when the cover 25 is moved at a constant angular speed from a position on the closed position side (for example, the closed position, or a position at which the cover 25 is opened by a predetermined amount from the closed position) to the open position (corresponding to a case in which f(N) in the Equation (3) is constant), a first state (90°<θ3<180°), in which the braking force from the oil damper 41 (braking force applied to the cover 25), which is transmitted from the arm 42 to the manual feed tray 24, is changed from a first braking force toward a second braking force smaller than the first braking force, a second state (θ3=90°), in which the braking force becomes the second braking force, and a third state (0<θ3<90°), in which the braking force is changed from the second braking force toward a third braking force larger than the second braking force. In other words, in the present Embodiment, when the cover (open/close portion) 25 is shifted from the closed state to the open state, the braking force transmitted from the arm 42 to the contacting surface 245a is changed by changing the positional relationship between the arm (first transmitting portion) 42 and the contacting surface (second transmitting portion) 245a with the movement of the manual feed tray (moving portion) 24. In the present Embodiment, when the cover 25 is shifted from the closed state to the open state, the arm 42 and the contacting surface 245a are relatively moved closer to each other.

In other words, in the present Embodiment, the braking force transmitting mechanism 43 is configured so that, in the case in which the cover 25 is moved from the closed position side (a first position side) to the open position (a second position) at a constant angular speed, the braking force transmitted to the manual feed tray 24 is changed depending on the position of the cover 25 between the closed position and the open position. In the present Embodiment, it can also be said that the groove cam 245 as a speed reduction ratio changing means is configured so as to cause, depending on the relative positional relationship between the cover 25 and the manual feed tray 24, a transmission ratio of the braking force, which is generated by the oil damper 41, from the arm 42 as a first transmitting portion to the manual feed tray 24 as a moving portion to be changed. In the present Embodiment, the braking force transmitting mechanism 43 is configured so that, in the case in which the cover 25 is moved from a position on the closed position side to the open position at a constant angular speed, the braking force transmitted to the manual feed tray 24 is changed in a direction for increasing before the cover 25 reaches the open position. Typically, in the case in which the cover 25 is moved from a position on the closed position side to the open position at a constant angular speed, the braking force transmitting mechanism 43 causes the braking force transmitted from the arm 42 to the manual feed tray 24, so as to be changed from a minimum value to a maximum value before the cover 25 reaches the open position.

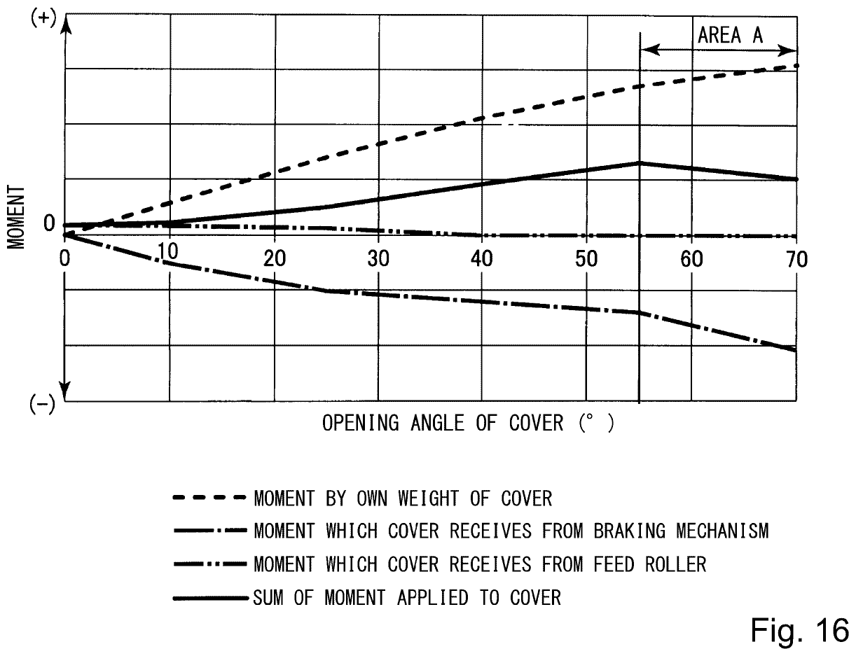

FIG. 16 is a graph view showing a relationship between the opening angle 01 of the cover 25 and the moment applied to the cover 25 upon the cover 25 opening due to own weight thereof. In FIG. 16, a horizontal axis represents the opening angle θ1 of the cover 25, and a vertical axis represents the moment applied to the cover 25. A value of a positive (+) moment is a value of the moment in the direction in which the cover 25 opens. A broken line represents the moment due to own weight of the cover 25, a dash-dotted line represents the moment which the cover 25 receives from the braking mechanism 4, a dashed double-dotted line is a moment which the cover 25 receives from the feeding roller 21, and a solid line is a total of the moments applied to the cover 25 (corresponding to the moment M).

In the present Embodiment, since the load F due to the braking mechanism 4 is applied to the cover 25 from immediately after the start of the opening (0°) of the cover 25, it becomes possible to reduce the moment in the direction in which the cover 25 opens. In addition, at a time of the start of the opening of the cover 25, since the cover 25 receives the urging force from the feeding roller 21, even if a user releases his/her hand from the cover 25 immediately after the user starts the opening of the cover 25, the cover 25 is opening without the operation by the user. Incidentally, in the present Embodiment, before the cover 25 reaches the open position, at a time at which the cover 25 is opened by a predetermined amount from the closed position, the cover 25 becomes substantially not to receive the urging force from the feeding roller 21.

Here, when an inertia moment of the cover 25 is defined as I, and an angular acceleration of the cover 25 is defined as α, from an equation of motion for a rotational motion, a relationship between the angular acceleration α and the moment M applied to the cover 25 can be expressed by the following Equation (4).

$$[ Equation 4 ]$$

$$αα = \frac{MM}{II} \qquad ( 4 )$$

According to the Equation (4), if the moment M applied to the cover 25 is suppressed low, the angular acceleration α can be lowered. In other words, with the load F due to the braking mechanism 4, by reducing the moment M in the direction in which the cover 25 opens, it becomes possible to slow the speed at which the cover 25 opens.

In addition, as shown in FIG. 16, in an area A in which the opening angle θ1 of the cover 25 is approximately 55° or more, the moment which the cover 25 receives from the braking mechanism 4 (the dash-dotted line) increases in a negative (−) direction. In other words, in the area A, a ratio, at which a negative (−) moment which the cover 25 receives from the braking mechanism 4 increases as the opening angle θ1 of the cover 25 increases, is larger than that in an area in which the opening angle θ1 of the cover 25 is smaller than in the area A. And while the moment M (solid line) applied to the cover 25 becomes larger as the opening angle θ1 of the cover 25 increases in the area in which the opening angle θ1 of the cover 25 is smaller than in the area A, in the area A, the moment M decreases. This is an effect due to the fact described above that the arm angle 03 becomes smaller than 90° in the area A.

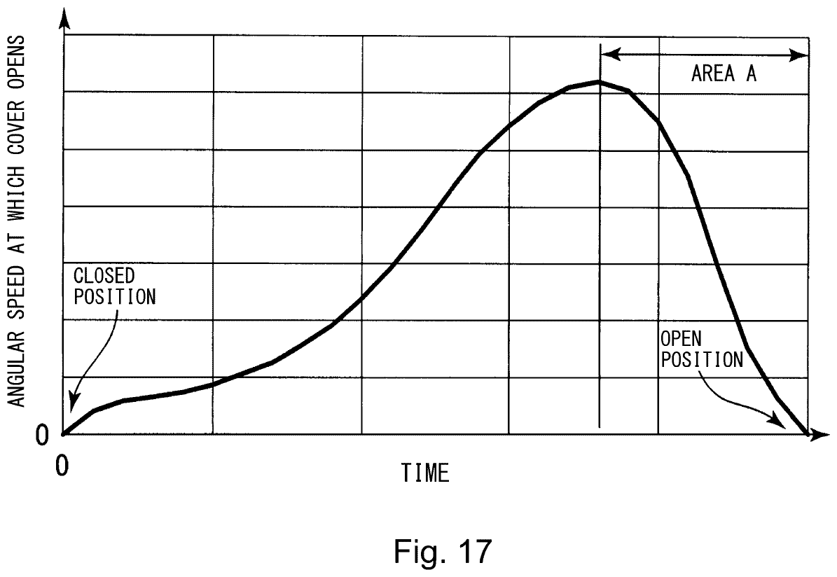

FIG. 17 is a graph view showing a relationship between an elapsed time and the angular speed at which the cover 25 opens upon the cover 25 opening due to own weight thereof. As shown in FIG. 17, in the area A in which the arm angle θ3 gets smaller than 90°, the angular speed at which the cover 25 opens becomes slow.

In this manner, in the present Embodiment, the braking force transmitting mechanism 43 is configured so as to take, when the cover 25 is moved from a position on the closed position side toward the open position due to own weight thereof (an action of gravity), etc., without the operation by the user, a first state (90°<θ3<180°) in which the angular speed of the cover 25 is changed from a first angular speed toward a second angular speed larger than the first angular speed, a second state in which the angular speed of the cover 25 becomes the second angular speed (θ3=90°), and a third state (0<θ3<90°) in which the angular speed of the cover 25 is changed from the second angular speed to a third angular speed smaller than the second angular speed. That is, in the present Embodiment, the braking force transmitting mechanism 43 is configured so that, when the cover 25 is moved (shifted) from a position on the closed position side to the open position without an operation by an operator, the angular speed of the cover 25 is changed in a direction for decreasing before the cover 25 reaches the open position.

In other words, in the present Embodiment, the braking force transmitting mechanism 43 is configured to take, when the cover 25 is moved from the closed position toward the open position due to own weight thereof, etc. without the operation by the user, a first state (90°<θ3<180°) in which a relative moving speed of the manual feed tray 24 with respect to the cover 25 is changed from a first speed toward a second speed faster than the first speed, a second state (θ3=90°) in which the moving speed becomes the second speed, and a third state (0<θ3<90°) in which the moving speed is changed from the second speed to a third speed slower than the second speed.

With the configuration as described above, it becomes possible, while suppressing the increase in the size of the apparatus, to slow the speed at which the cover 25 opens. In addition, it becomes possible, before the cover 25 completely opens, while maintaining the contacting state between the engaging shaft 421b of the braking mechanism 4 and the groove cam 245 formed in the manual feed tray 24, to increase the load of the braking mechanism 4 applied to the manual feed tray 24.

Therefore, it becomes possible to gradually decelerate the speed at which the cover 25 opens, and it becomes possible to appropriately reduce impact in the case in which the cover 25 moves to the open position due to own weight thereof, etc. without the operation by the user. As a result, for example, by suppressing generation of a collision sound, it becomes possible to realize an opening operation of the cover 25 which provides a high-class feeling.

Incidentally, in the present Embodiment, the shape of the groove cam 245 is configured to have a straight line shape, however, it is not limited thereto. For example, by configuring the shape of the groove cam into a cam shape such as a curved surface shape, with respect to the arm angle θ3, it becomes possible to set the load F due to the braking mechanism 4 (the braking force applied to the cover 25) more finely. For example, to the angular speed shown in FIG. 17, it may be configured so that a change rate of the angular speed of the cover 25 in the area A becomes larger (or smaller), or that a change rate of the angular speed of the cover 25 in the area in which the opening angle θ1 is smaller than in the area A becomes larger (or smaller).

In addition, in the present Embodiment, the cover 25 is closed by a user manually operating. Upon the cover 25 being moved from the open position toward the closed position, by the manual feed tray 24 moving in interrelation with the cover 25, the engaging shaft 421b of the braking mechanism 4 becomes in contact with another contacting surface (a side surface of the long wall portion on the downstream side in the feeding direction FD) 245b (see FIG. 11) of the groove cam 245. And, by the cover 25 being moved to the closed position, the arm 42 is returned from the state shown in FIG. 15 to the state shown in FIG. 11.

In addition, in the present Embodiment, the braking mechanism 4 is provided to the cover 25, however, the braking mechanism 4 may be provided to the manual feed tray 24. The manual feed tray 24 and the cover 25 move relatively to each other. Therefore, in the present Embodiment, it is possible to configure by appropriately adapting the elements (the oil damper 41 and the arm 42), which are provided to the cover 25 as one member of the cover 25 and the manual feed tray 24 for the braking of the cover 25, so as to be provided to the manual feed tray 24. In addition, in the present Embodiment, it is possible to configure by appropriately adapting the element (the groove cam 245 (contacting surface 245a)), which is provided to the manual feed tray 24 as the other member of the cover 25 and the manual feed tray 24 for the braking of the cover 25, so as to be provided to the cover 25. In this manner, it is sufficient that the moving portion includes one of the first transmitting portion and the second transmitting portion, and the open/close portion includes the other of the first transmitting portion and the second transmitting portion.

### Effect

As described above, according to the present Embodiment, it becomes possible to improve the degree of freedom in the disposition of the braking mechanism 4, suppress the increase in the size of the apparatus, and in the case in which the cover 25 moves to the open position due to own weight thereof, etc. without the operation by the user, to slow the speed at which the cover 25 opens.

In addition, according to the present Embodiment, it becomes possible to transmit the braking force from the oil damper 41, by the braking force transmitting mechanism 43, via the manual feed tray 24, to the cover 25. In the present Embodiment, the braking force transmitting mechanism 43 is configured to include the arm 42 of which the engaging shaft 421b is formed in the leading end portion, and the groove cam 245 (contacting surface 245a) formed in the manual feed tray 24. By configuring in this manner, by the settings of the shape, etc. of the groove cam 245, for example, while suppressing the increase in the size of the apparatus, it becomes easy to finely set the braking force applied to the cover 25. Therefore, compared to a configuration in which a plurality of gear portions for transmitting braking force are provided coaxially with the swing axis of the cover 25 to control the braking force, for example, it becomes possible, while suppressing the increase in the size of the apparatus, to improve the degree of freedom in the control of the braking force applied to the cover 25.

Thus, according to the present Embodiment, while suppressing the increase in the size of the apparatus, it becomes possible to improve the degree of freedom in the control of the braking force applied to the cover 25, and reduce the impact in the case in which the cover 25 moves to the open position due to own weight thereof, etc. without the operation by an operator.

### Embodiment 2

Next, another Embodiment of the present invention will be described. Basic configurations and operations of an image forming apparatus in the present Embodiment are the same as those of the image forming apparatus in the Embodiment 1. Therefore, in the image forming apparatus in the present Embodiment, to those elements having functions or configurations which are the same as or corresponding to those of the image forming apparatus in the Embodiment 1, the same reference numerals as in the Embodiment 1 will be attached, and detailed description thereof will be omitted.

The present Embodiment is an embodiment in which shapes (functions) of the arm 42 and the engaging shaft 421b, which is formed at the leading end portion thereof, in the Embodiment 1 are changed to a shape (function) of a cam.

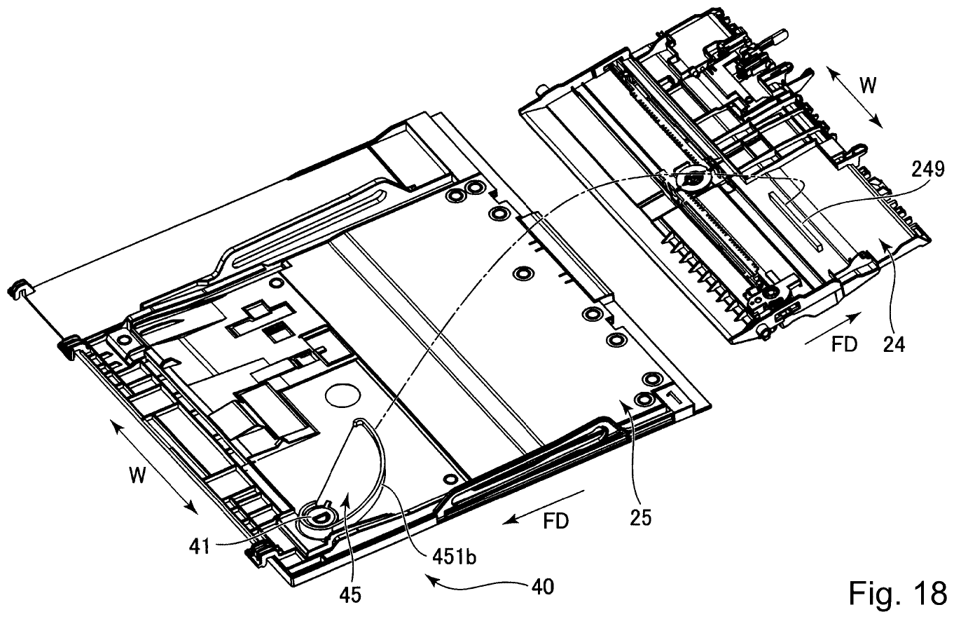

FIG. 18 is an exploded perspective view of a manual feed feeding portion 20 illustrating a configuration of a braking mechanism 40 in the present Embodiment.

In the present Embodiment, similarly to the Embodiment 1, the braking mechanism 40 is provided to a cover 25. In the present Embodiment, the braking mechanism 40 is configured to include an oil damper 41, which constitutes a braking force generating portion, and a cam 45 as a first transmitting portion. The cam 45 is swingable about a rotation axis of the oil damper 41. A fixing method of the oil damper 41 to the cover 25, and an attaching method of the cam 45 to the oil damper 41, are the same as those for the oil damper 41 and the arm 42 in the Embodiment 1. In the cam 45, a cam surface 451b as a first transmitting portion is formed. The cam surface 451b is configured, in a state in which a manual feed tray 24 is assembled to the cover 25, so as to be in contact (engaged) with a contacting wall 249 (a side surface on a downstream side in a feeding direction FD of the contacting wall 249) as a second transmitting portion formed in the manual feed tray 24.

In the present Embodiment, the cam surface 451b is configured to have a curved surface shape, which is convex toward an outside of the cam 45. In addition, in the present Embodiment, the contacting wall 249 is configured to have a straight line shape extending along (in the present Embodiment, approximately parallel to) the widthwise direction W. In this manner, in the present Embodiment, the shapes (functions) of the arm 42 and the engaging shaft 421b, which is formed at the leading end portion thereof, in the Embodiment 1 are changed to the shape (function) of the cam 45. In the present Embodiment, a braking force transmitting mechanism 43 is configured to include the cam 45, in which the cam surface 451b is formed, and the contacting wall 249 formed in the manual feed tray 24.

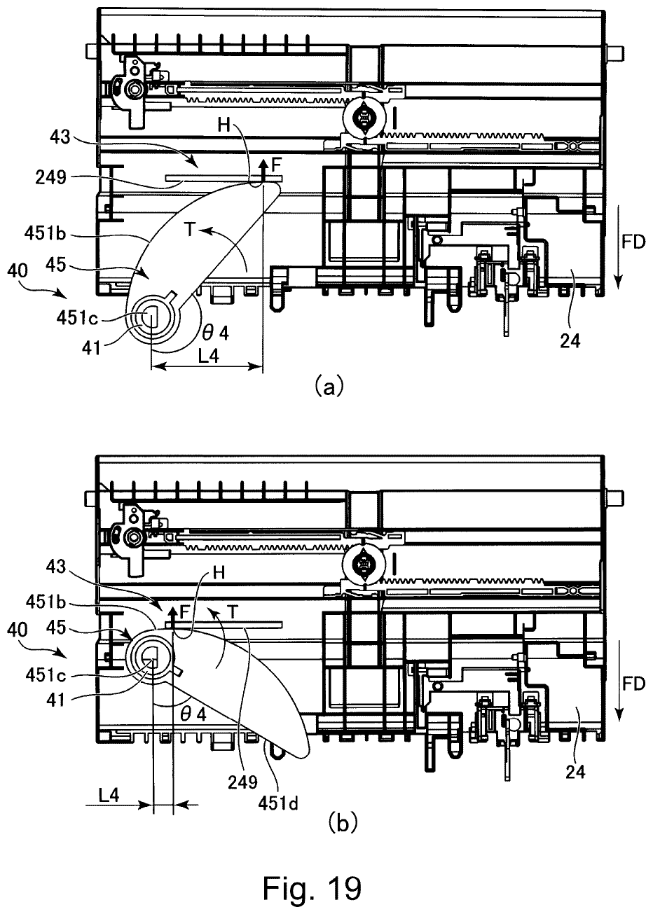

FIG. 19, part (a) and part (b), includes plan views of the manual feed feeding portion 20 illustrating a positional relationship between the manual feed tray 24 and the braking mechanism 40 (illustrates a state as viewed in approximately parallel to a swing axis direction of the cam 45. In addition, illustration of the cover 25 is omitted.). Part (a) of FIG. 19 shows a state in which the cover 25 is positioned at a closed position, and part (b) of FIG. 19 shows a state immediately before the cover 25 is positioned at an open position.

In a direction approximately perpendicular to the moving direction FD of the manual feed tray 24, a distance from a swing center 451 c of the cam 45 to a contacting position (a contacting point) H between the contacting wall 249 and the cam surface 451b is defined as L4. In addition, an angle (“cam angle”) formed between the moving direction FD of the manual feed tray 24 and the cam 45 (a side surface 451d of the cam 45 extending in a straight line shape) is defined as θ4. As shown in part (a) and part (b) of FIG. 19, the distance L4 is changed depending on the cam angle θ4. Thus, when a torque of the oil damper 41 is defined as T=f(N) (N is a rotational speed of the cam 45) and L4 =f(θ4), a load F due to the braking mechanism 40, which is applied to the manual feed tray 24, can be expressed by the following Equation (5).

$$[ Equation 5 ]$$

$$FF = \frac{ff ( NN )}{ff ( θθ 4 )} \qquad ( 5 )$$

In a process in which the cover 25 moves from the closed position to the open position, the contacting position (contacting point) H of the cam 45 and the contacting wall 249 are changed from the position shown in part (a) of FIG. 19 to the position shown in part (b) of FIG. 19. Upon this, since L4 =f(θ4) gradually becomes smaller, according to the Equation (5), the load F due to the braking mechanism 40, which is applied to the manual feed tray 24, increases in the process in which the cover 25 moves from the closed position to the open position.

And according to the Equation (1) described in the Embodiment 1, in the process in which the cover 25 moves from the closed position to the open position, the moment M applied in the direction, in which the cover 25 opens, gradually becomes smaller.

In this manner, in the present Embodiment, the braking force transmitting mechanism 43 is configured so that, in a case in which the cover 25 is moved from a position on the closed position side to the open position at a constant angular speed, the braking force transmitted to the manual feed tray 24 is changed depending on the position of the cover 25 between the closed position and the open position. In the present Embodiment, it can also be said that the contacting wall 249 as a speed reduction ratio changing means is configured so as to cause, depending on the relative positional relationship between the cover 25 and the manual feed tray 24, a ratio of a relative moving speed of the cam 45 as the first transmitting portion to the manual feed tray 24 as the moving portion to be changed. In particular, in the present Embodiment, the braking force transmitting mechanism 43 is configured so that, in the case in which the cover 25 is moved from a position on the closed position side to the open position at the constant angular speed, the braking force transmitted to the manual feed tray 24 is changed in a direction for increasing before the cover 25 reaches the open position.

Thus, also with the configuration in the present Embodiment, it becomes possible to obtain the same effects as those in the Embodiment 1.

Incidentally, in the present Embodiment, the braking mechanism 40 is provided to the cover 25, however, the braking mechanism 40 may be provided to the manual feed tray 24. The manual feed tray 24 and the cover 25 move relatively to each other. Therefore, in the present Embodiment, it is possible to configure by appropriately adapting the elements (the oil damper 41 and the cam 45), which are provided to the cover 25 for the braking of the cover 25, so as to be provided to the manual feed tray 24. In addition, in the present Embodiment, it is possible to configure by appropriately adapting the element (the contacting wall 249), which is provided to the manual feed tray 24 for the braking of the cover 25, so as to be provided to the cover 25.

### Embodiment 3

Next, another Embodiment of the present invention will be described. Basic configurations and operations of an image forming apparatus in the present Embodiment are the same as those of the image forming apparatus in the Embodiment 1. Therefore, in the image forming apparatus in the present Embodiment, to those elements having functions or configurations which are the same as or corresponding to those of the image forming apparatus in the Embodiment 1, the same reference numerals as in the Embodiment 1 will be attached, and detailed description thereof will be omitted.

In the present Embodiment, the braking mechanism, which is provided on the cover 25 side in the Embodiment 1, is changed so as to be provided on the manual feed tray 24 side, and the braking mechanism, which is configured to swing in the Embodiment 1, is changed to be configured to be straightly moved.

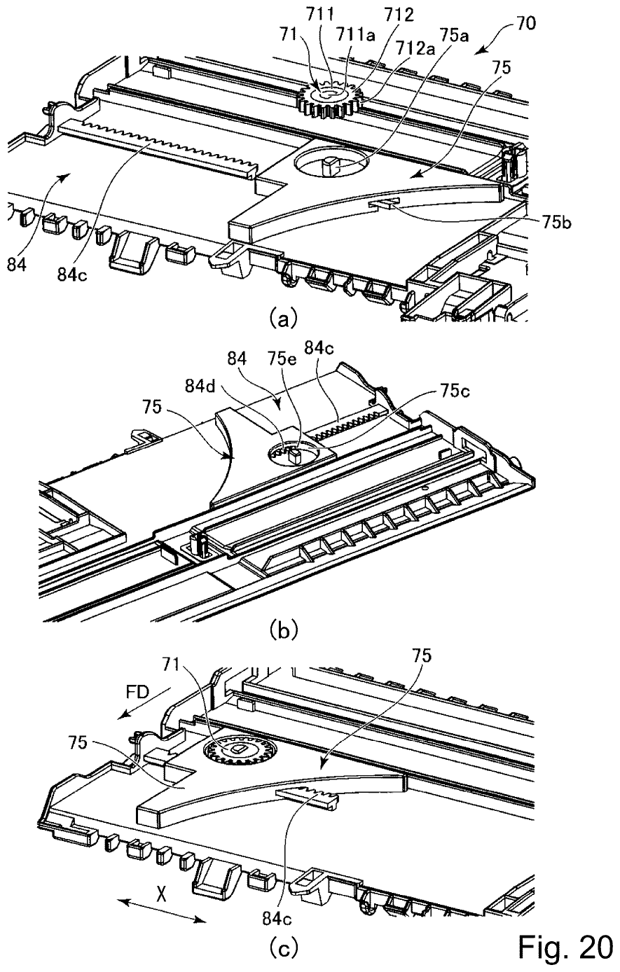

FIG. 20 is a perspective view of a part of a manual feed tray 84 illustrating a procedure for assembling a braking mechanism 70 to the manual feed tray 84 in the present Embodiment.

In the present Embodiment, the braking mechanism 70 is configured to include an oil damper 71, which constitutes a braking force generating portion, a slider (braking cam) 75, to which the oil damper 71 is attached, and a rack guide 84c fixed to the manual feed tray 84. The rack guide 84c transmits a movement of the slider 75 to the oil damper 71 (i.e., transmits a load of the oil damper 71 to the slider 75), and regulates a moving direction of the slider 75. The oil damper 71 includes a fixing portion 711 and a rotating portion 712, and in the fixing portion 711, a fixing hole 711a, of which a cross-section has a D-shape, is formed, and on an outer periphery of the rotating portion 712, a gear 712a is formed.

Upon assembling the braking mechanism 70 to the manual feed tray 84, first, as shown in part (a) of FIG. 20, the oil damper 71 is attached to a damper hole 75c formed in the slider 75. Upon this, into the fixing hole 711a formed in the fixing portion 711 of the oil damper 71, so as a damper shaft 75a, of which a cross-section has the D-shape and which is formed so as to be projected from a bottom portion of the damper hole 75c, to be inserted, the oil damper 71 is attached to the damper hole 75c. Next, the rack guide 84c, of which a cross-section has a T-shape and which is formed in the manual feed tray 84, is inserted into a slide guide 75b, of which a cross-section has a T-shape and which is formed so as to penetrate the slider 75. As shown in part (b) of FIG. 20, in the damper hole 75c, a cutout 75e is formed, and in the rack guide 84c, a rack 84d is formed. Therefore, upon inserting the rack guide 84c into the slide guide 75b as described above, in the cutout 75e, the rack 84d of the rack guide 84c and the gear 712a of the oil damper 71 are meshed with each other. By the slider 75, the oil damper 71 and the rack guide 84c being assembled as shown in part (c) of FIG. 20, it becomes possible for the slider 75, in a state in which the load due to the oil damper 71 is generated, to move along an x direction in part (c) of FIG. 20 crossing (in the present Embodiment, approximately perpendicular to) a moving direction FD of the manual feed tray 84.

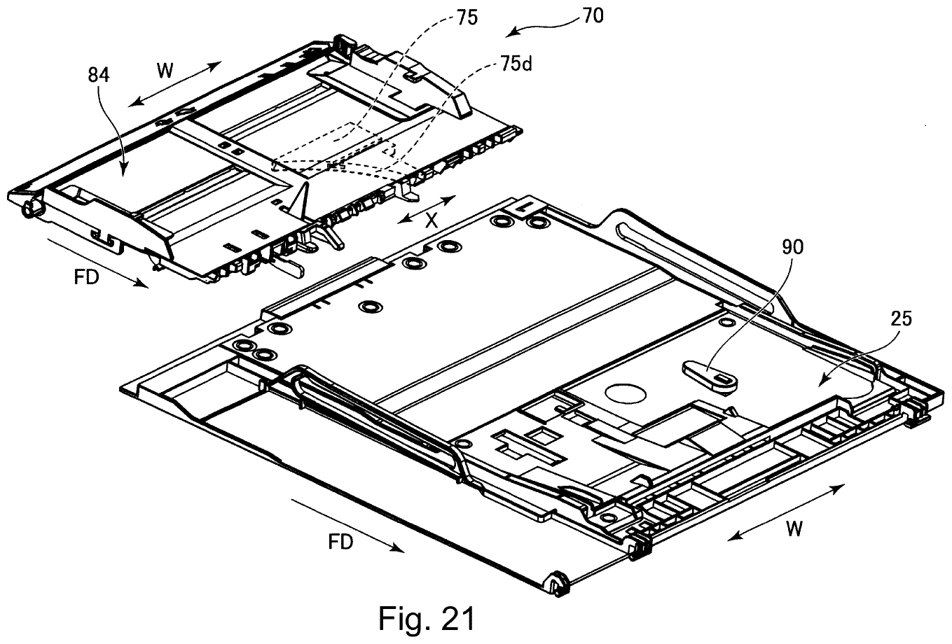

FIG. 21 is an exploded perspective view illustrating the manual feed tray 84, to which the braking mechanism 70 in the present Embodiment is assembled, and a cover 25. In the slider 75 as a first transmitting portion, a cam surface 75d is formed, and to the cover 25, a pressing member 90 as a second transmitting portion is fixed. In the present Embodiment, the cam surface 75d is configured to have a curved surface shape, which is convex toward an inside of the slider 75. By attaching the manual feed tray 84, to which the braking mechanism 70 is assembled, to the cover 25, the cam surface 75d formed in the slider 75 and the pressing member 90 fixed to the cover 25 are brought into contact (engaged) with each other. In the present Embodiment, a braking force transmitting mechanism 43 is configured to include the slider 75, in which the cam surface 75d is formed, and the pressing member 90 fixed to the cover 25.

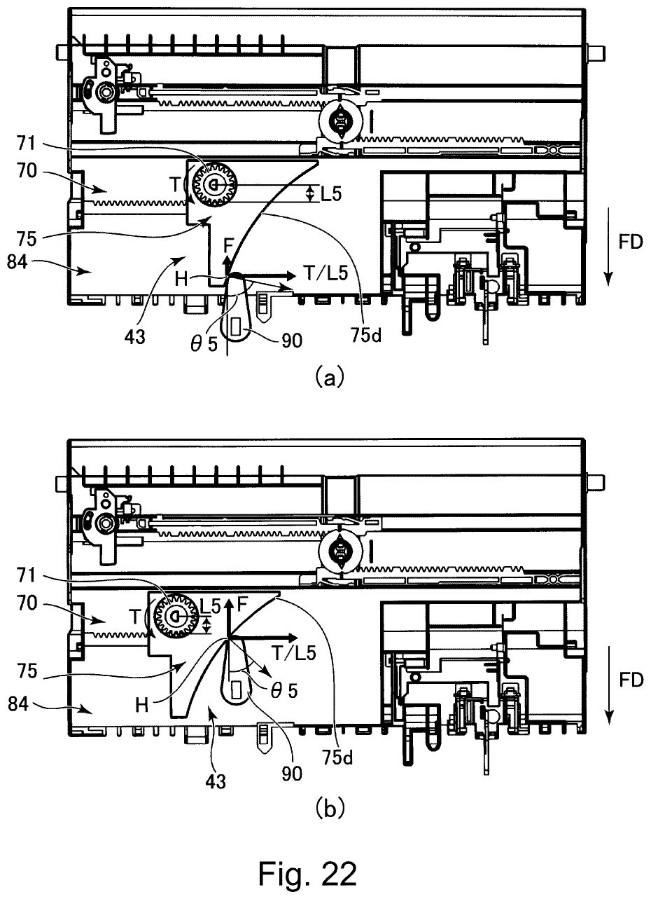

FIG. 22, part (a) and part (b), includes plan views of a manual feed feeding portion 20 illustrating a positional relationship between the manual feed tray 84 and the braking mechanism 70 in the present Embodiment (illustrates a state as viewed in approximately parallelly to a rotational axis direction of the rotating portion 712 of the oil damper 71. In addition, illustration of the cover 25 is omitted.). Part (a) of FIG. 22 shows a state in which the cover 25 is positioned at a closed position, and part (b) of FIG. 22 shows a state immediately before the cover 25 is positioned at an open position.

As shown in part (a) and part (b) of FIG. 22, a load F due to the braking mechanism 70, which is applied to the manual feed tray 84, in an opposite direction to the moving direction FD of the manual feed tray 84 is changed depending on an angle (“cam contacting angle”) 05 between a normal direction of the cam surface 75d at a contacting position (contacting point) H between the cam surface 75d and the pressing member 90 and the moving direction FD of the manual feed tray 84. Therefore, when a torque of the oil damper 71 is defined as T=f(N) (N is a rotational speed of the oil damper 71), the load F due to the braking mechanism 70, which is applied to the manual feed tray 84, in the opposite direction to the moving direction FD can be expressed by the following Equation (6). Incidentally, L5 is a pitch radius of the gear 712a of the oil damper 71.

$$[ Equation 6 ]$$

$$FF = \frac{ff ( NN )}{2 \times LL 5} \cdot sin ( 2 \times θθ 5 ) \qquad ( 6 )$$

In a process in which the cover 25 moves from the closed position to the open position, the slider 75 is changed from a position shown in part (a) of FIG. 22 to a position shown in part (b) of FIG. 22. Upon this, the cam contacting angle θ5 gradually becomes smaller. Here, according to the Equation (6), in a case in which θ5=45°, the load F becomes maximum. Thus, by setting the shape of the cam surface 75d so that θ5=45° before the cover 25 reaches the open position, it becomes possible to decelerate the cover 25.

In this manner, in the present Embodiment, the braking force transmitting mechanism 43 is configured so that, in a case in which the cover 25 is moved from a position on the closed position side to the open position at a constant angular speed, the braking force transmitted to the manual feed tray 84 is changed depending on the position of the cover 25 between the closed position and the open position. In particular, in the present Embodiment, the braking force transmitting mechanism 43 is configured so that, in the case in which the cover 25 is moved from a position on the closed position side to the open position at a constant angular speed, the braking force transmitted to the manual feed tray 84 is changed in a direction for increasing before the cover 25 reaches the open position.

Thus, also with the configuration in the present Embodiment, it becomes possible to obtain the same effects as those in the Embodiment 1.

Incidentally, in the present Embodiment, the braking mechanism 70 is provided to the manual feed tray 48, however, the braking mechanism 70 may be provided to the cover 25. The manual feed tray 48 and the cover 25 move relatively to each other. Therefore, in the present Embodiment, it is possible to configure by appropriately adapting the elements (the oil damper 71, the slider 75 and the rack guide 84c), which are provided to the manual feed tray 48 for the braking of the cover 25, so as to be provided to the cover 25. In addition, in the present Embodiment, it is possible to configure by appropriately adapting the element (the pressing member 90), which is provided to the cover 25 for the braking of the cover 25, so as to be provided to the manual feed tray 84.

### Other Embodiments

As described above, the present invention has been described based on the specific Embodiments, however, the present invention is not limited to the Embodiments described above.

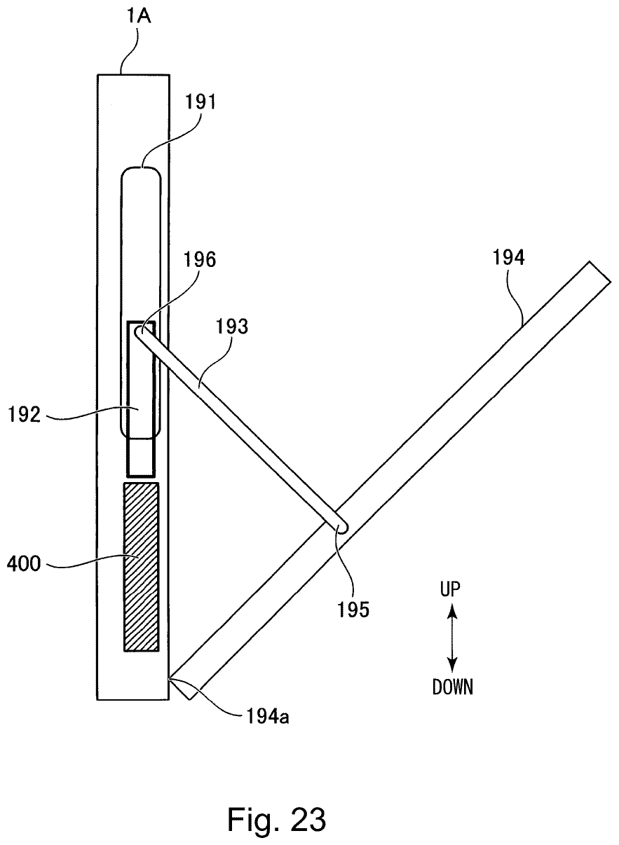

In the Embodiments described above, the present invention is applied to the cover of the manual feed feeding portion, however, it is not limited thereto. The present invention, for example, may be applied to a door for jam processing, which is provided to the image forming apparatus. An example thereof will be described using FIG. 23. FIG. 23 is a schematic view of a vicinity of the door for jam processing, which is provided to an image forming apparatus (illustrates a state as viewed in approximately parallelly to a swing axis direction of the door.). The image forming apparatus shown in FIG. 23 includes a main assembly 1A and a door 194 which is openable and closable relative to the main assembly 1A. The door 194 is opened and closed, about a swing axis 194a positioned on a lower end portion side thereof when positioned at a closed position, so as an upper end portion side thereof when positioned at the closed position to be rotated, by being swung between the closed position and an open position. To the main assembly 1A, a link hole portion 191 is provided. To the door 194, a link member 193 is coupled rotatably about a first coupling portion 195 of one end portion thereof. A second coupling portion 196 of an end portion on an opposite side to the first coupling portion 195 of the link member 193 is coupled to the link hole portion 191 of the main assembly 1A rotatably and in a slidably movable manner along the link hole portion 191.

In addition, to the main assembly 1A, a moving portion 192 is provided, and the link member 193 is engaged (coupled) with the moving portion 192. The moving portion 192 is configured, by the link member 193, so as to slide and move in interrelation with an opening/closing operation of the door 194. In addition, in the main assembly 1A, a braking mechanism 400 is provided on a lower side of the moving portion 192. And, by the braking mechanism 400 and the moving portion 192 being in contact with each other, a braking force due to the braking mechanism 400 is transmitted via the link member 193 to the door 194. By this, in a case in which the door 194 moves to the open position due to own weight thereof, etc. without the operation by the user, it becomes possible to slow a speed at which the door 194 opens. As the braking mechanism 400, the same mechanisms as those described in the Embodiments 1 through 3 may be used. In other words, it is possible to configure by appropriately adapting the elements, which are provided to the cover 25 for the braking of the cover 25 in the Embodiments described above, so as to be provided to the main assembly 1A in the present Embodiment. In addition, it is possible to configure by appropriately adapting the element, which is provided to the manual feed tray 24 for the braking of the cover 25 in the Embodiments described above, so as to be provided to the moving portion 192. Thus, also with the configuration as shown in FIG. 23, it becomes possible to obtain the same effects as those in the Embodiments described above.

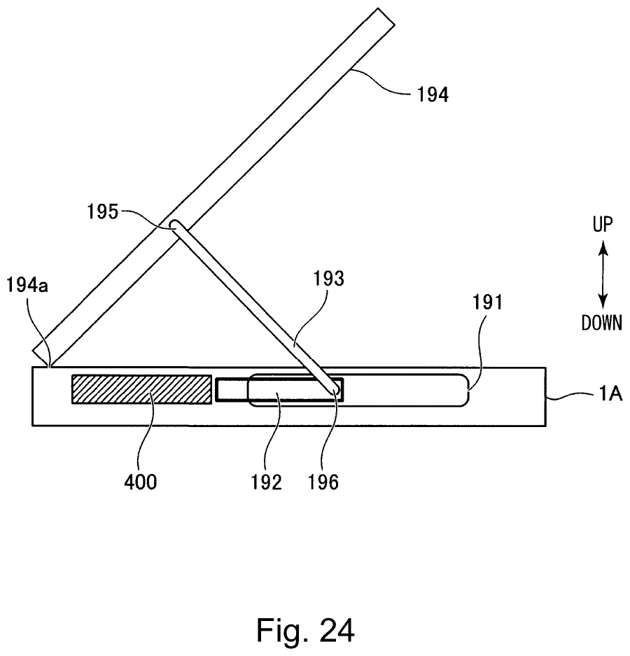

In addition, in the above, the examples of the image forming apparatus having the configuration provided with the open/close portion which is shifted from the closed state to the open state by being rotated relative to the main assembly due to own weight thereof (the first position of the open/close portion is the closed position, and the second position of the open/close portion is the open position), has been described. However, the present invention is not limited to such Embodiments. It may be configured that an image forming apparatus is provided with an open/close portion which is shifted from an open state to a closed state by being rotated relative to the main assembly due to own weight thereof (a first position of the open/close portion is an open position, and a second position of the open/close portion is a closed position). An example thereof will be described using FIG. 24. FIG. 24 is a schematic view illustrating, similarly to the example described using FIG. 23, a vicinity of a door 194 of an image forming apparatus provided with an openable and closable door 194 (illustrates a state as viewed approximately parallelly to a swing axis direction of the door.). However, in the image forming apparatus shown in FIG. 24, the door 194 is an open/close portion which is shifted, by being rotated relative to a main assembly 1A due to own weight thereof, from an open state to a closed state. To those elements having functions or configurations which are the same as or corresponding to those in FIG. 23, the same reference numerals as in FIG. 23 are attached. In the image forming apparatus shown in FIG. 24, the door 194 is opened and closed, about a swing axis 194a positioned on a lower end portion side thereof when positioned at the open position, so as an upper end portion side thereof when positioned at the open position to be rotated, by being swung between the open position and the closed position. In this case, upon the door 194 moving from the open position to the closed position, the door 194 may move to the closed position due to own weight thereof, etc. without the operation by the user. In such a configuration, by incorporating a braking mechanism, in the case in which the door 194 moves to the closed position due to own weight thereof, etc. without the operation by the user, it becomes possible to slow a speed at which the door 194 closes.

As it can be seen from FIG. 23 and FIG. 24, both in the case in which the open/close portion is shifted from the closed state to the open state by being rotated relative to the main assembly 1A due to own weight thereof, and in the case in which the open/close portion is shifted from the open state to the closed state, directions of the main assembly and the open/close portion are different, however, as the configuration for the braking of the open/close portion, the same configuration may be used. Therefore, the configurations for the braking of the open/close portion in any of the examples described above, including the example of FIG. 23, may also be applied to the configuration, in which the open/close portion is shifted from the open state to the closed state by being rotated relative to the main assembly 1A due to own weight thereof as in the example of FIG. 24. In that case, the open/close portion may be the cover for the manual feed feeding portion as described in the Embodiments 1 through 3, or may be the door for jam processing as described in the example of FIG. 23. In addition, the braking mechanism and the moving portion may be provided on the open/close portion side, or may be provided on the main assembly side. In addition, in a case in which the braking mechanism and the moving portion is provided on the open/close portion side, the braking mechanism may be provided to the open/close portion, or may be provided to the moving portion. In addition, in a case in which the braking mechanism and the moving portion is provided on the main assembly side, the braking mechanism may be provided to the main assembly, or may be provided to the moving portion.

In addition, the open/close portion is not limited to the cover for the manual feed feeding portion and the door for jam processing. For example, as a door, which enables an operator to access an inside of a main assembly, besides the door for jam processing, a door, etc. for maintenance and/or replacement of an element for an image forming process (for example, replacement of a process cartridge and/or a toner cartridge) may be exemplified.

In addition, in the Embodiments described above, the braking force generating portion is constituted by the oil damper, which is an example of a damper, however, it is not limited thereto. The working fluid (braking force generating medium), which is interposed between the fixing portion and the movable portion may be any of oil, air, powder, etc. For example, instead of the oil damper in the Embodiments described above, an air damper may be used.

In addition, in the Embodiments described above, the present invention is applied to the image forming apparatus of electrophotographic type, however, the present invention is not limited thereto. The present invention, for example, may also be applied to an image forming apparatus of inkjet type, which forms an image on a sheet by discharging an ink liquid from a nozzle.

According to the present invention, it becomes possible, while suppressing the increase in the size of the apparatus, to improve the degree of freedom in the control of the braking force applied to the open/close portion, and to reduce the impact in the case in which the open/close portion moves due to own weight thereof, etc. without the operation by an operator.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-008796, filed Jan. 21, 2025, which is hereby incorporated by reference herein in its entirety.

What is claimed is:

1. An image forming apparatus comprising:
a main assembly;
an open/close portion configure to take an open state in which the open/close portion is open relative to the main assembly and a closed state in which the open/close portion is closed relative to the main assembly, the open/close portion shifting from one state of the open state and the closed state to the other state by rotating relative to the main assembly due to its own weight;
a moving portion coupled with the open/close portion and configured to move relative to both the main assembly and the open/close portion with rotation of the open/close portion;
a damper configured to generate a braking force for braking the open/close portion by moving with movement of the moving portion;
a first transmitting portion coupled with the damper and configured to transmit the braking force; and
a second transmitting portion to which the braking force is transmitted from the first transmitting portion by being in contact with the first transmitting portion and configured to transmit the braking force to the open/close portion,
wherein the moving portion is provided with one of the first transmitting portion and the second transmitting portion,
wherein the open/close portion is provided with the other one of the first transmitting portion and the second transmitting portion, and
wherein when the open/close portion is shifted from the one state to the other state, the braking force transmitted from the first transmitting portion to the second transmitting portion is changed by changing a positional relationship between the first transmitting portion and the second transmitting portion with the movement of the moving portion.

2. The image forming apparatus according to claim 1, wherein when the open/close portion is shifted from the one state to the other state, the first transmitting portion and the second transmitting portion are relatively moved closer to each other.

3. The image forming apparatus according to claim 2, wherein as a moving speed of the damper increase, the braking force generated by the damper becomes large.

4. The image forming apparatus according to claim 2, wherein the moving portion is a manual feed tray.

5. The image forming apparatus according to claim 1, wherein the damper is provided on one of the open/close portion and the moving portion,
wherein the moving portion is slidably movable relative to the open/close portion,
wherein the first transmitting portion is a rotatable arm provided on the one portion, and
wherein the second transmitting portion is provided on the other of the open/close portion and the moving portion, and is in contact with a contacting portion provided on the arm.

6. The image forming apparatus according to claim 5, wherein the one portion is the open/close portion and the other portion is the moving portion.

7. The image forming apparatus according to claim 1, wherein the damper is provided on one of the open/close portion and the moving portion,
wherein the moving portion is slidably movable relative to the open/close portion,
wherein the first transmitting portion is a rotatable cam provided on the one portion, and
wherein the second transmitting portion is provided on the other of the open/close portion and the moving portion, and is in contact with a cam surface provided on the cam.

8. The image forming apparatus according to claim 7 wherein the one portion is the open/close portion and the other portion is the moving portion.

9. The image forming apparatus according to claim 1 wherein the damper is provided on one of the open/close portion and the moving portion,
wherein the moving portion is slidably movable relative to the open/close portion along a first direction,
wherein the first transmitting portion is provided on the one portion and is a slider slidably movable along a second direction crossing the first direction, and
wherein the second transmitting portion is provided on the other of the open/close portion and the moving portion, and is in contact with a cam surface provided on the slider.

10. The image forming apparatus according to claim 9 wherein the one portion is the moving portion and the other portion is the open/close portion.

11. The image forming apparatus according to claim 1 wherein the one state is the closed state and the other state is the open state.

12. The image forming apparatus according to claim 1 wherein the one state is the open state and the other state is the closed state.

13. The image forming apparatus according to claim 1 wherein the open/close portion is a cover for opening and closing a feeding portion which feeds a sheet to the main assembly, and
wherein the moving portion includes a sheet supporting portion for supporting the sheet fed from the feeding portion to the main assembly.

14. The image forming apparatus according to claim 1 wherein the open/close portion is a door for allowing an operator to access an inside of the main assembly.

15. The image forming apparatus according to claim 1 wherein when the open/close portion is shifted from the one state to the other state at a constant angular speed, the damper is configured so that the braking force transmitted to the open/close portion is changed in a direction for increasing before the open/close portion takes the other state.

16. The image forming apparatus according to claim 1 wherein when the open/close portion is shifted from the one state to the other state without an operation by an operator, the open/close portion is configured so that an angular speed thereof is changed in a direction for decreasing before the open/close portion takes the other state.

17. The image forming apparatus according to claim 1, wherein the damper is configured so that the braking force generated thereby is changed in response to a moving speed of the moving portion.

18. The image forming apparatus according to claim 1, wherein the damper is an oil damper.

19. The image forming apparatus according to claim 1, wherein the damper is an air damper.
